(19) United States
(12) Patent Application Publication
(10) Pub. No.: US 2025/0176013 A1
(43) Pub. Date: May 29, 2025

(54) DATA ROUTING AND SERVING NODE SWITCHING IN A COMMUNICATION SYSTEM

(71) Applicant: VIREWIRX, Inc., San Diego, CA (US)

(72) Inventors: Jaspreet Singh, San Diego, CA (US); Siddhartha Mallik, San Diego, CA (US); Joseph Kwee Tze Heng, San Diego, CA (US); Jose Armando Oviedo, San Diego, CA (US); Vidur Bhargava, San Diego, CA (US)

(21) Appl. No.: 18/959,272

(22) Filed: Nov. 25, 2024

Related U.S. Application Data
(60) Provisional application No. 63/603,079, filed on Nov. 27, 2023.

(51) Int. Cl. H04W 74/00; H04W 74/08; H04W 92/12

(52) U.S. Cl. CPC H04W 74/002; H04W 74/08; H04W 92/12

(57) ABSTRACT

Aspects of the disclosure relate to a multipoint environment in which a first approach, a second approach, or a combination of a first and second approach can be used to serve outgoing stations (STAs) with minimal service disruptions. For example, in a first approach, an outgoing access point (AP) is assigned a non-serving all stations (non-SAS) contention-based access period (CBAP) resource in which the outgoing AP is allowed to transmit packets remaining in a queue just to outgoing STAs. In a second approach, an outgoing AP is assigned a non-SAS CBAP resource in which the outgoing AP is disallowed from serving the outgoing STAs, causing the outgoing APs to flush packets remaining in queue for the outgoing STAs. The outgoing AP informs an AP controller of an identity of the flushed packets, and the AP controller then instructs an incoming AP to transmit those packets to the outgoing STA.

### CROSS-REFERENCE TO RELATED APPLICATIONS

This application claims the benefit of U.S. Provisional Application No. 63/603,079, entitled “DATA ROUTING AND SERVING NODE SWITCHING IN A COMMUNICATION SYSTEM” and filed on Nov. 27, 2023, which is hereby incorporated by reference herein in its entirety. Any and all applications for which a foreign or domestic priority claim is identified in the Application Data Sheet as filed with the present application, are hereby incorporated by reference under 37 CFR 1.57.

### BACKGROUND

### Technical Field

Embodiments of this disclosure relate to wireless communication systems, such as multiple-input multiple output wireless communication systems with multiple serving nodes (e.g., access points) and multiple mobile users.

### Description of Related Technology

The types of modern computing devices continues to increase along with the differing and dynamic needs of each device. The wireless communication systems providing services to such devices are facing increasing constraints on resources and demands for quality and quantities of service. Accordingly, improvements in providing wireless communication services, such as in a system with multiple users and multiple access points, are desired.

### SUMMARY

One aspect of the disclosure provides a wireless communication device comprising an antenna. The wireless communication device further comprises a processor in communication with the antenna, wherein computer-executable instructions, when executed by the processor, cause the wireless communication device to: obtain a first scheduling message from an access point controller that allocates a first type of contention-based access period (CBAP) resource for serving a first station and that allocates a second type of CBAP resource; transmit a first packet to the first station during the first type of contention-based access period (CBAP) resource; transmit a second packet to the second station during the second type of CBAP resource; obtain a second scheduling message from the access point controller that indicates that the first type of CBAP resource is converting into a second instance of the second type of CBAP resource allocated to the wireless communication device; and transmit a third packet to the second station during the second instance of the second type of CBAP resource.

The wireless communication device of the preceding paragraph can include any sub-combination of the following features: where the first type of CBAP resource comprises a non-serve all stations (non-SAS) CBAP resource, and wherein the second type of CBAP resource comprises a SAS CBAP resource; where a second wireless communication device that is an outgoing access point for a third station transmits a third packet to the third station during a second instance of the first type of CBAP resource that is overlapping in time with the first type of CBAP resource; where the first packet is stored in a queue of the wireless communication device prior to the first scheduling message being obtained; where the first type of CBAP resource overlaps in time with the second type of CBAP resource; where the first scheduling message does not allocate any of the first type of CBAP resource to the wireless communication device for serving the second station; and where the wireless communication device comprises an access point.

Another aspect of the disclosure provides an access point controller comprising a network interface. The access point controller further comprises a processor in communication with the network interface, wherein computer-executable instructions, when executed by the processor, cause the access point controller to: determine that a first access point has served a first station and a second station in a first time period will not serve the first station in an upcoming second time period that follows the first time period; transmit a first scheduling message to the first access point that allocates a first type of contention-based access period (CBAP) resource to the first access point for serving the first station and a second type of CBAP resource to the first access point; determine that the first type of CBAP resource has expired; and transmit a second scheduling message to the first access point that indicates that the first type of CBAP resource is converting into a second instance of the second type of CBAP resource allocated to the first access point.

The access point controller of the preceding paragraph can include any sub-combination of the following features: where the first type of CBAP resource is a non-serve all stations (non-SAS) CBAP resource, and wherein the second type of CBAP resource is a SAS CBAP resource; where the first type of CBAP resource allocated to the first access point and a third instance of the first type of CBAP resource allocated to a second access point each occur during one of an overlapping time period or a non-overlapping time period; where the computer-executable instructions, when executed, further cause the access point controller to determine that the first type of CBAP resource has expired based on expiry of a timer; where the first scheduling message further indicates that the first access point is allowed to transmit a data packet only to the first station during the first type of CBAP resource; where a second access point serves a third station in the first time period, and wherein the computer-executable instructions, when executed, further cause the access point controller to determine that the second access point is not serving the third station in the second time period; where the first scheduling message allocates the first type of CBAP resource to the first access point for serving the first station during the second time period, and wherein a third scheduling message allocates a second instance of the first type of CBAP resource to the second access point for serving the third station during the second time period; where the first type of CBAP resource allocated to the first access point and the first type of CBAP resource allocated to the second access point each occur during one of an overlapping time period or a non-overlapping time period; where the first scheduling message allocates the first type of CBAP resource to the first access point for serving the first station during a first time period, and wherein a third scheduling message allocates a second instance of the first type of CBAP resource to the second access point for serving the third station during the second time period that follows the first time period; where the computer-executable instructions, when executed, further cause the access point controller to set a time duration of the first type of CBAP resource to be one of equal to an absolute time duration or a value based on a period of running a scheduler function; where the computer-executable instructions, when executed, further cause the access point controller to: obtain an indication from the first access point that no data packets intended for the first station remain in a queue of the first access point, and transmit a second scheduling message to the first access point that indicates that the first type of CBAP resource has expired; where the first access point transmits a first packet to the first station during the first type of CBAP resource, wherein the computer-executable instructions, when executed, further cause the access point controller to transmit a third scheduling message and an activation trigger message to a second access point that will subsequently serve the first station in the second time period; where the computer-executable instructions, when executed, further cause the access point controller to set a time duration of the first type of CBAP resource based on an indication of a volume of data in a queue of the first access point that is associated with the first station that is received prior to transmission of the first scheduling message; and where the computer-executable instructions, when executed, further cause the access point controller to: determine that a second access point that does not serve a third station in the first time period will serve the third station in a third time period that follows the first time period, and configure the second access point with a non-serve all stations (non-SAS) CBAP resource during the third time period.

Another aspect of the disclosure provides an access point controller comprising a network interface. The access point controller further comprises a processor in communication with the network interface, wherein computer-executable instructions, when executed by the processor, cause the access point controller to: determine that a first access point that serves a first station and a second station in a first time period will not serve the first station in a second time period that follows the first time period; transmit a scheduling message to a first access point that allocates a first type of contention-based access period (CBAP) resource to the first access point in which the first station is absent from a list of stations that the first access point is authorized to serve during the first type of CBAP resource; receive a packet sequence identification number from the first access point of a first packet intended for the first station that has been flushed from a transmission queue of the first access point; and transmit an activation trigger message to a second access point that will serve the first station that includes the identification of the first packet.

The access point controller of the preceding paragraph can include any sub-combination of the following features: where the identification of the first packet comprises a sequence ID of the first packet; where the computer-executable instructions, when executed, further cause the access point controller to transmit a backup copy of the first packet to the second access point prior to transmission of the scheduling message, wherein the activation trigger message causes the second access point to transmit the backup copy of the first packet (and/or any other packet existing in the data queue of the second access point at that time instance, having sequence ID greater than the sequence ID of the first packet) to the first station; where the computer-executable instructions, when executed, further cause the access point controller to transmit a second packet to the first access point and a backup copy of the second packet to the second access point prior to transmission of the scheduling message; where the computer-executable instructions, when executed, further cause the access point controller to transmit the scheduling message and a second activation trigger message to the second access point prior to reception of the identification of the first packet from the first access point, wherein the second activation trigger message causes the second access point to transmit the backup copy of the second packet (and/or any other packet existing in the data queue of the second access point at that time instance, having sequence ID greater than the sequence ID of the second packet) to the first station; and where the computer-executable instructions, when executed, further cause the access point controller to transmit the activation trigger message in response to a determination that the second activation trigger message was transmitted within a threshold period of time of a current time and a sequence ID of the first packet is less than a sequence ID of the second packet.

Another aspect of the disclosure provides a wireless communication device comprising an antenna. The wireless communication device further comprises a data queue. The wireless communication device further comprises a processor in communication with the antenna, wherein computer-executable instructions, when executed by the processor, cause the wireless communication device to: obtain a scheduling message from an access point controller that allocates a first type of contention-based access period (CBAP) resource to the wireless communication device in which a first station is absent from a list of stations that the wireless communication device is authorized to serve during the first type of CBAP resource; flush, from the message queue, any data packet intended for the first station; and transmit, to the access point controller, an identification of each data packet flushed from the message queue.

The wireless communication device of the preceding paragraph can include any sub-combination of the following features: where the wireless communication device comprises an access point.

Another aspect of the disclosure provides an access point controller comprising a network interface. The access point controller further comprises a processor in communication with the network interface, wherein computer-executable instructions, when executed by the processor, cause the access point controller to: determine that a first access point that serves a first station in a first scheduling interval will not serve the first station in a second scheduling interval that follows the first scheduling interval; and transmit a scheduling message to the first access point that allocates a non-serve all stations (non-SAS) contention-based access period (CBAP) resource to the first access point.

The access point controller of the preceding paragraph can include any sub-combination of the following features: where the scheduling message allocates the non-SAS CBAP resource to the first access point for serving the first station, and wherein reception of the scheduling message by the first access point causes the first access point to transmit a data packet in a queue that is intended for the first station during the non-SAS CBAP resource; and where the scheduling message allocates the non-SAS CBAP resource to the first access point in which the first station is absent from a list of stations that the first access point is authorized to serve during the non-SAS CBAP resource, and wherein the computer-executable instructions, when executed, further cause the access point controller to: receive an identification from the first access point of a first packet intended for the first station that has been flushed from a transmission queue of the first access point, and transmit an activation trigger message to a second access point that will serve the first station that includes the identification of the first packet.

Another aspect of the disclosure provides a computer-implemented method as generally shown and described herein and equivalents thereof.

Another aspect of the disclosure provides a non-transitory computer readable medium storing instructions, which when executed by at least one computing device, perform a method as generally shown and described herein and equivalents thereof.

### BRIEF DESCRIPTION OF THE DRAWINGS

Embodiments of this disclosure will now be described, by way of non-limiting example, with reference to the accompanying drawings.

FIG. 1A is a diagram of a multipoint environment in which multiple stations and access points can communicate with each other according to an embodiment.

FIG. 1B is a schematic diagram illustrating a wireless network that includes the baseband unit according to an embodiment.

FIG. 2 is a block diagram of the multipoint environment of FIG. 1A illustrating the operations performed by the components of the multipoint environment to serve an outgoing STA using a first approach according to an embodiment.

FIG. 3 is a block diagram of the multipoint environment of FIG. 1A illustrating the operations performed by the components of the multipoint environment to serve an outgoing STA using a first approach and an immediate activation trigger message according to an embodiment.

FIG. 4 is a block diagram of the multipoint environment of FIG. 1A illustrating the operations performed by the components of the multipoint environment to serve an outgoing STA using a second approach according to an embodiment.

FIG. 5 is a block diagram of the multipoint environment of FIG. 1A illustrating the operations performed by the components of the multipoint environment to serve an outgoing STA using a second approach and an activation trigger message according to an embodiment.

FIG. 6 is a flow diagram depicting an outgoing STA serving routine illustratively implemented by an AP, according to one embodiment.

FIG. 7 is a flow diagram depicting an outgoing STA serving routine illustratively implemented by an AP controller, according to one embodiment.

FIG. 8 is a block diagram illustrating an example baseband unit and remote radio unit according to an embodiment.

FIG. 9 is a schematic block diagram of an example STA according to an embodiment.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. The headings provided herein are for convenience only and do not necessarily affect the scope or meaning of the claims.

As wireless networks are increasingly used to run services sensitive to reliability and/or latency issues (e.g., media streaming, video chat, virtual reality, augmented reality, etc.), any situations that negatively affect reliability and/or latency can be problematic. For example, in a wireless network, a station (STA) typically has a serving access point (AP), selected from amongst the set of one or more APs that comprise the wireless network. The serving AP may be selected by an AP controller (also referred to herein as a central controller) based on channel conditions between the STA and one or more APs. The AP controller can also route packets (e.g., data packets) intended for the STA to the serving AP, and the serving AP can then transmit the packets to the STA. In some cases, a STA and/or a serving AP may be mobile and the channel conditions between the STA and the serving AP may deteriorate over time due to the changed position(s) and/or changed orientations of the STA and/or the serving AP. Alternatively or in addition, other STAs and/or other serving APs may transmit packets that cause interference between the STA and the serving AP and a deterioration in the channel conditions between the STA and the serving AP. As a result, the AP controller may decide to switch the serving AP of the STA to a new serving AP that has better channel conditions with the STA. The old serving AP may be referred to herein as an “outgoing AP” and the new serving AP may be referred to herein as an “incoming AP.” A STA for which the serving AP switch has occurred may be referred to herein as an “outgoing STA” (with respect to the outgoing AP) and/or as an “incoming STA” (with respect to the incoming AP). Once the AP controller switches the serving AP of a STA, the AP controller may cease routing packets intended for the STA to the outgoing AP and may instead start routing packets intended for the STA to the incoming AP.

During this serving AP switch (which can also be referred to herein as an AP handover), it may be possible that some packets intended for the STA are not transmitted to the STA and/or are not received by the STA. As a result, any services being run by the STA could be disrupted. The goal during a serving AP switch may therefore be to ensure a seamless transition between serving APs without data disruption (e.g., no missing packets) to the STA and/or with minimal overhead (e.g., a reduction in duplicate packet transmissions).

To ensure a seamless transition between serving APs, the AP controller typically sends scheduling information to the different APs, informing each AP about the set of STAs that the AP is to serve and the time-frequency resources with which to serve each STA, where certain time-frequency resources may be provided for outgoing APs as described in greater detail below. Optionally, the scheduling information may also include data like beams for an AP to use to transmit/receive data to/from a STA, a modulation and coding scheme (MCS) for an AP to use to transmit data to a STA, and/or the like. The schedule may be specified in terms of a fixed time duration (of say T milliseconds), that the receiving AP may apply repeatedly (over intervals of T milliseconds) until a new scheduling message is received from the AP controller. The AP controller may send the scheduling information to different APs periodically and/or in response to an event (e.g., when the serving AP and/or the AP beam for a STA changes). The schedule generated by the typical AP controller may include a mix of one or more schedule periods (SPs) and one or more contention-based access periods (CBAPs), spanning the total scheduling duration of T milliseconds. In an SP in which the AP controller schedules an AP to transmit, the AP is typically provided dedicated resources for serving STAs (e.g., an AP is assigned to a time resource in the SP and can freely transmit data within this time, without having to wait for the transmission medium to become available because another AP or STA is currently using the transmission medium during the time resource). In a CBAP, one or more APs and/or STAs may contend for the transmission medium during the same time resource (e.g., the AP or STA may have to wait to transmit data if the transmission medium is currently being used by another AP or STA).

The AP controller typically provides SP resources for an AP to serve one or more STAs for which the AP is the serving AP, and typically provides CBAP resources for an AP to serve any STA. Thus, an outgoing AP can use the CBAP resources to serve its outgoing STAs (e.g., a STA that will no longer be served by an outgoing AP due to a switch event in which the STA is being reassigned to an incoming AP). While the typical AP controller may cease routing packets intended for a STA to an outgoing AP once a serving AP switch occurs, the outgoing AP may still have pending packets intended for the STA in the queues (e.g., driver queue, universal serial bus (USB) queue, firmware queue, etc.) of the outgoing AP and therefore the CBAP resource may be helpful in allowing the outgoing AP to transmit the remaining packets intended for the STA that are in the queue of the outgoing AP.

While the CBAP resource can be beneficial in allowing an STA to receive packets intended for the STA that were not transmitted by the outgoing AP prior to the serving AP switch, outgoing APs often struggle to serve successfully the outgoing STA using the assigned CBAP resource. In particular, the outgoing AP has to contend for the transmission medium with other APs and/or STAs, and this can result in situations in which the outgoing AP is unable to transmit all of the packets remaining in the queue that are intended for the outgoing STA before the CBAP resource is no longer available because other APs and/or STAs may be transmitting packets during the resource as well. Similarly, the outgoing AP may have other packets in the queues that are intended for STA(s) that the outgoing AP will continue to serve, and transmission of these packets to other STA(s) served by the outgoing AP during the CBAP resource may result in the outgoing AP being unable to transmit all of the packets remaining in the queue that are intended for the outgoing STA before the CBAP resource is no longer available. In addition, the outgoing AP may become an outgoing AP for an outgoing STA because the channel conditions between the outgoing AP and the outgoing STA may be poor or progressively degrading. Due to the poor channel conditions, the outgoing AP may experience a large number of failed transmissions and/or retransmissions to the outgoing STA, and it may not be possible for the outgoing AP to transmit all of the packets remaining in the queues that are intended for the outgoing STA before the CBAP resource is no longer available due to the transmission failures and/or the repeated retransmissions.

Not being able to transmit all of the packets remaining in the queue that are intended for an outgoing STA during a CBAP resource can be problematic for several reasons. For example, the outgoing STA may miss packets, which can cause reliability and/or latency issues in services running on the outgoing STA. As another example, other STAs that are continuing to be served by the outgoing AP may also experience missed packets (and therefore reliability and/or latency issues in services running thereon) because the outgoing AP may have a finite memory buffer for storing packets intended for STAs. The memory buffer may become full or nearly full due to the inability to serve packets to the outgoing STA, and may be unable to store packets to serve to other STAs as a result.

Accordingly, described herein are several improved approaches for serving outgoing STAs to minimize the problems discussed above that are experienced when the AP controller schedules CBAP resources for outgoing APs using conventional methods. For example, in a first approach, an AP controller, after determining to switch the AP for a STA, can configure the schedule for an outgoing AP such that at least a portion of the total CBAP resource assigned to the outgoing AP restricts the outgoing AP to only serve outgoing STA(s), rather than serve all STAs. A portion of a CBAP resource in which an outgoing AP is restricted to serving only outgoing STA(s) may be referred to herein as a non-serve all STAs (non-SAS) CBAP resource. Conversely, a portion of a CBAP resource in which an outgoing AP is allowed to serve any STA (including outgoing STAs) may be referred to herein as a serve all STAs (SAS) CBAP resource. The AP controller can assign one common (e.g., overlapping in time) non-SAS CBAP resource to one or more outgoing APs to serve their respective outgoing STAs (or a subset of their respective outgoing STAs) and/or can assign multiple non-SAS CBAP resources to one or more outgoing APs, where each non-SAS CBAP resource is to be used by one or more outgoing APs to serve their respective outgoing STAs (or a subset of their respective outgoing STAs). If multiple non-SAS CBAP resources are configured by the AP controller, each non-SAS CBAP resource may occur in succession (e.g., the non-SAS CBAP resources may be scheduled contiguously such that the non-SAS CBAP resources are collectively complete before a SAS CBAP resource or SP resource begins), or the multiple non-SAS CBAP resources may occur in a discontiguous manner.

The time duration for which the AP controller provides non-SAS CBAP resources to an outgoing AP, after making an AP switch for a STA, can be configurable (e.g., by the AP controller). For example, the time duration may be an absolute time duration (e.g., in milliseconds), or a time duration in terms of multiples of some fixed quantity (e.g., a period of running the scheduler function at the AP controller). In either case, the AP controller may be configured by the system administrator with a static value for this time duration (e.g., at AP controller or system bring up or start up), or the AP controller may be configured to dynamically optimize this time duration at run time (e.g., where the time duration changes based on current system conditions). For instance, the AP controller may determine or anticipate the volume of data that an outgoing AP may still need to serve to the outgoing STA(s), where this information may be available at the AP controller based on existing (periodic or aperiodic) feedback from the AP about the status of the AP data queues. The AP controller can then determine the time duration based on the determined or anticipated volume of data that the outgoing AP may need to serve to the outgoing STA(s). The AP controller may also determine the time duration based on the number of outgoing STA(s) that the outgoing AP is required to serve and/or based on the number of other AP(s) that are going to contend for the medium with the outgoing AP.

As another example, the time duration may be determined by the AP controller based on an initial determination and subsequent feedback received from the outgoing AP. In particular, the AP controller may set an initial time duration of the non-SAS CBAP resource (e.g., based on one or more factors described herein). In response to receiving a scheduling message that includes a schedule with non-SAS CPAB resources where the (outgoing) AP is allowed to serve only specific STA(s) (e.g., outgoing STA(s)), the outgoing AP may subsequently indicate to the AP controller when no more packets intended for these outgoing STA(s) remain in the queue of the outgoing AP. If the outgoing AP provides this indication before expiry of the non-SAS CBAP resource, the AP controller may cause the non-SAS CBAP resource to end early and send a new scheduling message to the AP(s) earlier than initially scheduled. Otherwise, if the outgoing AP does not provide this indication before expiry of the non-SAS CBAP resource (e.g., packets intended for outgoing STA(s) still remain in the outgoing APs queue), then the non-SAS CBAP resource may expire at the conclusion of the time duration. After the time duration of the non-SAS CBAP resources assigned to an AP has expired, the AP controller may send a new scheduling message to the AP such that the total CBAP resource becomes a SAS CBAP resource. It is to be noted that the determination of an AP being an outgoing or incoming AP is made at the AP controller, and it causes the AP controller to send out appropriate scheduling messages to the AP. The AP by itself may or may not be explicitly made aware of this determination, and may only see the impact of that determination via the schedule that the AP receives in a scheduling message.

As described herein, the AP controller may set a timer to track the time that has passed since a non-SAS CBAP resource was assigned to an (outgoing) AP. The AP controller may determine that the non-SAS CBAP resource has expired once the timer reaches zero or the time duration length. Optionally, if before expiry of the timer (e.g., if before the non-SAS CBAP resource has expired) the AP controller determines that the outgoing AP has become an outgoing AP for another STA (e.g., due to another STA that was being served by the AP being reassigned to a new incoming AP), then the AP controller may restart the timer for the existing non-SAS CBAP resource, and/or assign new or additional non-SAS CBAP resources to the AP. The AP controller also sends a new scheduling message to the AP, indicating the updated set of CBAP resources (SAS and non-SAS) and an updated set of STAs to be served by the AP during the CBAP resource (SAS and non-SAS).

At the same time at which the AP controller assigns non-SAS CBAP resources to outgoing APs, for APs that are not outgoing APs, the AP controller may continue to schedule SAS CBAP resources for such APs. In some embodiments, the non-SAS CBAP resource assigned to outgoing APs may be exclusive to the outgoing APs (e.g., no non-outgoing APs may be scheduled to transmit during the time period occupied by the non-SAS CBAP resource). In other embodiments, the AP controller may assign one or more outgoing APs to a non-SAS CBAP resource and one or more non-outgoing APs to a SAS CBAP resource, where the non-SAS CBAP resource and the SAS CBAP resource occupy the same or overlapping time period.

The first approach described above may be suitable in situations in which the channel conditions between the outgoing AP and the outgoing STA(s) is still acceptable (e.g., the signal to noise ratio (SNR) of transmissions through the channel is above a threshold SNR). However, if the channel conditions between the outgoing AP and the outgoing STA(s) is poor and/or if the AP controller otherwise decides to take a different approach for serving outgoing STAs, the AP controller can, in a second approach, configure the schedule for an outgoing AP such that the outgoing AP is instructed not to serve the outgoing STA(s) once the serving AP switching occurs. Specifically, the AP controller may configure the entire CBAP resource for the outgoing AP to be non-SAS, and remove the outgoing STA(s) from the list of STAs that the AP is allowed to serve in the entire CBAP resource. Upon receiving this schedule via a scheduling message and determining that the outgoing STA(s) are no longer servable even in any of the CBAP resources, the outgoing AP may flush (e.g., drop from its queues) any remaining packets intended for outgoing STAs that remain in the queues of the outgoing AP (e.g., driver queue, USB queue, firmware queue, etc., which are referred to herein as data queues). The outgoing AP may then transmit a message to the AP controller that provides information on the flushed packets (e.g., a sequence ID (e.g., a packet sequence identification number) of a first flushed packet (e.g., a lowest sequence ID of the flushed packets), a sequence ID of some or all flushed packets, a range of sequence IDs of packets that are flushed, etc.).

When the AP controller initially routed the packets intended for the outgoing STAs to the outgoing AP, the AP controller may have routed a backup copy of one or more of these packets to one or more APs that the AP controller determined could potentially become serving APs for the outgoing STAs in the future. The AP controller also indicates to the AP that these are backup copies (e.g., via an explicit flag in each packet's header, or via a message that the AP controller sends to the AP some or every time the AP controller changes the role of the AP for a given STA between being a serving AP or a backup AP or neither), and the AP then determines in response that the backup copy packets are not required to be sent by the AP to the STA unless explicitly instructed to by the AP controller (e.g., through an activation trigger message from the AP controller to the AP, as described in greater detail below), potentially at a time in the future. Thus, an incoming AP for the outgoing STAs may have in a queue backup copies of one or more packets flushed by the outgoing AP. Upon receiving the flushed packet information, the AP controller can transmit an activation trigger message to an incoming AP that indicates to the incoming AP which packet(s) (from amongst the backup packets available in the data queue of the incoming AP at that time instant) to transmit to the outgoing STA (e.g., packets with sequence IDs that are equal to or greater than the sequence ID of the first packet flushed by the outgoing AP, packets with sequence IDs matching some or all of the flushed packets, packets with sequence IDs that fall within the range of sequence IDs of flushed packets, etc.). In response, the incoming AP may start transmitting the identified packets to the outgoing STA(s) to ensure that the outgoing STAs do not miss any packets intended for the respective outgoing STAs.

As in the first approach, the time duration for which the AP controller provides non-SAS CBAP resources to an outgoing AP, after making the AP switch for a STA, can be configurable (e.g., by the AP controller). For example, the time duration may be an absolute time duration (e.g., in milliseconds), or a time duration in terms of multiples of some fixed quantity (e.g., a period of running the scheduler function at the AP controller). In either case, the AP controller may be configured by the system administrator with a static value for this time duration (e.g., at AP controller or system bring up or start up), or the AP controller may be configured to dynamically optimize this time duration at run time (e.g., where the time duration changes based on current system conditions). For instance, the AP controller may determine or anticipate the volume of data that an outgoing AP may need to flush, where this information may be available at the AP controller based on existing (periodic or aperiodic) feedback from the AP about the status of the AP data queues. The AP controller can then determine the time duration based on the determined or anticipated volume of data that the outgoing AP may need to flush. As in the first approach, the AP controller may also determine this time duration based on the number of outgoing STAs for the outgoing AP, and/or the number of other AP(s) that are going to contend for the medium with the outgoing AP. As in the first approach, the AP controller may update this time duration based on any subsequent feedback from the outgoing AP. After the time duration of the non-SAS CBAP resources assigned to an AP has expired, the AP controller may send a new scheduling message to the AP such that the total CBAP resource becomes a SAS CBAP resource. It is to be noted that the determination of an AP being an outgoing or incoming AP is made at the AP controller, and it causes the AP controller to send out appropriate scheduling messages to the AP. The AP by itself may or may not be explicitly made aware of this determination, and may only see the impact of that determination via the schedule that the AP receives via a scheduling message.

As described herein, the AP controller may set a timer to track the time that has passed since a non-SAS CBAP resource was assigned to an (outgoing) AP. The AP controller may determine that the non-SAS CBAP resource has expired once the timer reaches zero or the time duration length. Optionally, if before expiry of the timer (e.g., if before the non-SAS CBAP resource has expired) the AP controller determines that the outgoing AP has become an outgoing AP for another STA (e.g., due to another STA that was being served by the AP being reassigned to a new incoming AP), then the AP controller may restart the time for the existing non-SAS CBAP resource, and/or assign new or additional non-SAS CBAP resources to the AP. The AP controller also sends a new scheduling message to the AP, indicating the updated set of CBAP resources (SAS and non-SAS) and an updated set of STAs to be served by the AP during the CBAP resource (SAS and non-SAS).

As in the first approach, at the same time at which the AP controller assigns non-SAS CBAP resources to outgoing APs, for APs that are not outgoing APs, the AP controller may continue to schedule SAS CBAP resources for such APs. In some embodiments, the non-SAS CBAP resource assigned to outgoing APs may be exclusive to the outgoing APs (e.g., no non-outgoing APs may be scheduled to transmit during the time period occupied by the non-SAS CBAP resource). In other embodiments, the AP controller may assign one or more outgoing APs to a non-SAS CBAP resource and one or more non-outgoing APs to a SAS CBAP resource, where the non-SAS CBAP resource and the SAS CBAP resource occupy the same time period.

While the data flush and subsequent activation trigger approach has been described above with respect to the second approach, the data flush and subsequent activation trigger approach can be applied to the first approach as well. Specifically, in the first approach, when the AP controller sends a new scheduling message to the outgoing AP (providing the outgoing AP with non-SAS CBAP resource(s) to serve the outgoing STA(s)), the AP controller can also explicitly instruct (either through the scheduling message, or a separate message) the outgoing AP to flush the remaining packets in its data queues meant for the outgoing STA(s). This strategy minimizes the data packets that the outgoing AP still needs to send to the outgoing STA(s), while still providing the outgoing AP a (non-SAS) CBAP resource to serve the outgoing STA(s) with any packets that could not actually be flushed, e.g., because those packets were already beyond a point in the data transmission pipeline where they could be flushed. As in the second approach, the outgoing AP then transmits a message to the AP controller that provides information on the flushed packet ID(s), which the AP controller uses to send an activation trigger message to the incoming AP(s) for the STA(s).

Optionally, with respect to the first approach or the second approach, at the time that the AP controller switches the serving AP for a STA, the AP controller can also transmit an activation trigger message to the incoming AP (which is referred to herein as bicasting). Reception of the activation trigger message may cause the incoming AP to immediately begin transmitting (backup) packets to the outgoing STA when the serving AP switch occurs. By sending an activation trigger message when the serving AP switch occurs, the AP controller can guard against scenarios where the outgoing AP is unsuccessful or delayed in sending some or all of the remaining packets in the queue of the outgoing AP that are intended for the outgoing STA. In this case, there may be duplication of packets sent to the outgoing STA (e.g., both the outgoing AP and the incoming AP may send the same packet to the outgoing STA, especially in the first approach). To prevent or minimize the effects of overhead due to excessive duplication, the AP controller can limit the activation trigger message to more recent packets. For example, the AP controller could limit the activation trigger message to packets belonging to more recent content (e.g., the N most recent video frames, the N most recent slices of the M most recent video frames, the N most recent audio packets, the N most recent data packets, etc.).

If the AP controller transmits an activation trigger message to the incoming AP when the serving AP switch occurs, the AP controller may transmit one or more additional activation trigger messages at a future time. For example, the AP controller may receive an indication of packets flushed by the outgoing AP after the AP controller transmits the initial activation trigger message. As a result, the AP controller may send another activation trigger message to the incoming AP to ensure that the incoming AP transmits backup copies of the indicated packets to the outgoing STA if the incoming AP has not already done so. However, to prevent unnecessary activation triggers, the AP controller can apply a filter to determine if a new trigger needs to be sent to the AP. Specifically, the AP controller can determine a time that the last activation trigger message was sent to the incoming AP for a particular outgoing STA. If the last activation trigger message was sent within a threshold time period of a current time and was directed to a particular packet (e.g., a packet with a particular sequence ID), the AP controller can send a new activation trigger message to the same incoming AP for the same outgoing STA if the sequence ID of the packet associated with the new activation trigger message is less than the sequence ID of the packet associated with the last activation trigger message. Otherwise, if the last activation trigger message was sent earlier than a threshold time period before a current time, then the AP controller can send a new activation trigger message to the same incoming AP for the same outgoing STA.

While the filter for the activation triggers is motivated by a specific scenario above (e.g., when AP controller sends an activation trigger message to the incoming AP at the time of AP switch, and then receives a follow-up flushed packet information from the outgoing AP), the filter can be applied in general. In other words, the filtering can be done at all times, whenever a determination needs to be made by the AP controller whether it should send a new activation trigger message to an AP or not, regardless of the circumstances that caused this determination to be made.

In some embodiments, the AP controller may statically (e.g., at system bring up or start up) be configured to either pursue the first approach or the second approach and continue to implement the selected approach each time a new serving AP switch occurs. In other embodiments, the AP controller can be configured to dynamically select either the first approach or the second approach when a new serving AP switch occurs. For example, the AP controller may evaluate the channel conditions between the outgoing AP and the outgoing STA. If the SNR of the channel is above a threshold SNR level, then the AP controller may implement the first approach. However, if the SNR of the channel is below the threshold SNR level, then the AP controller may implement the second approach. The decision could also be influenced by the information the AP controller may have about the status of the queues at the AP, such as the volume of the data the (outgoing) AP still has in its queues for the (outgoing) STAs, and/or by the number of outgoing STA(s), and/or the number of other AP(s) that are going to contend for the medium with the outgoing AP.

While the preceding embodiments describe approaches to configure non-SAS CBAPs for the outgoing APs, in another embodiment, the AP controller may configure the incoming AP(s) with non-SAS CBAP resources, and specifically restrict the incoming AP(s) to serve only their respective incoming STA(s) during such non-SAS CBAP resources. This helps provide additional (quasi-dedicated) resources to the incoming AP(s) to serve the incoming STA(s), in addition to dedicated resources provided in the scheduled periods (SPs). This can be especially useful when the bicasting approach is used by the AP controller, as the AP controller explicitly triggers the incoming AP to also send backup data to the STA, in addition to any new (non-backup) data that the AP controller starts routing to the incoming AP at the time of the AP switch.

The decision to provide non-SAS CBAP resources to outgoing and/or incoming APs may be independent. For instance, the AP controller may be statically configured (e.g., at system bring up or start up) to provide non-SAS CBAP resources to outgoing APs only and not to incoming APs, or vice-versa, or to both. The AP controller may also be configured to make such decisions dynamically depending on prevailing conditions.

As in previous embodiments of non-SAS CBAP resources for outgoing APs, the time duration for which the AP controller may configure an incoming AP with non-SAS CBAP resources can be configurable, either set to a certain value statically (at system bring up or start up), or can be configured to be dynamically adjustable based on prevailing conditions.

The AP controller, the APs, and the STAs described herein may operate in a multipoint environment. In an embodiment, the multipoint environment described herein is designed to operate at higher frequencies, such as at millimeter wave (mmW) frequencies, such as between 24 GHz to 300 GHz. In general, mmW frequencies can encompass at least some frequency ranges between 2 GHz to 3 GHZ, at least some frequency ranges in the Super high frequency (SHF) bands (e.g., 3 GHz to 30 GHz), and/or at least some frequency ranges in the Extremely High Frequency (EHF) bands (e.g., 30 GHz to 300 GHz). The techniques described herein can be applied to networks operating at any suitable range of frequencies. In addition, the techniques described herein can be used for a variety of use cases, such as media streaming, video chat, virtual reality, augmented reality, etc.

As used herein, an AP serving a STA means that the AP sends data to the STA. As described herein, an AP controller generates a schedule for serving STAs. The AP controller can communicate the schedule to one or more APs by transmitting a scheduling message to each AP.

### Multipoint Association and Diversity

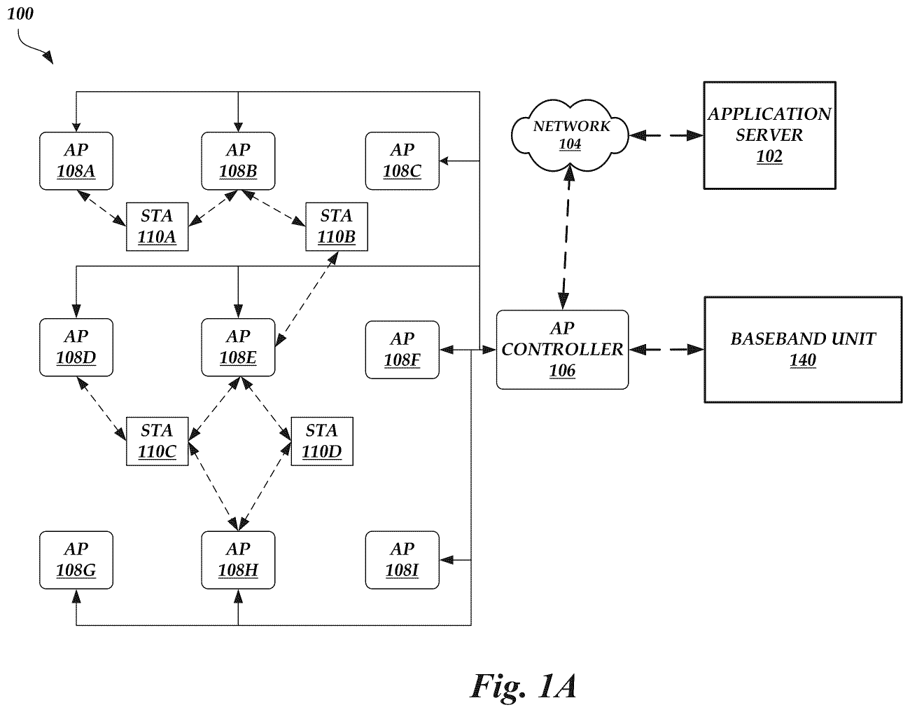

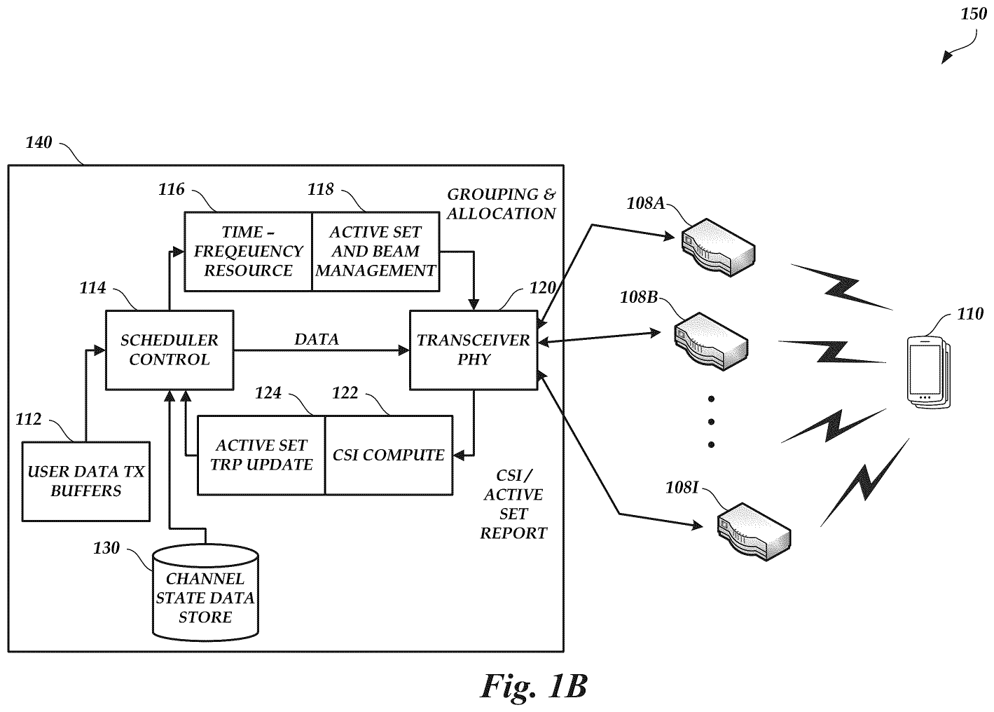

FIG. 1A is a diagram of a multipoint environment 100 in which multiple STAs 110A-D and APs 108A-I can communicate with each other according to an embodiment. As illustrated in FIG. 1A, the multipoint environment 100 includes a plurality of APs 108A-I, a plurality of STAs 110A-D, an AP controller 106, a baseband unit 140, and an application server 102 that optionally communicates with the AP controller 106 via a network 104. In an embodiment, data packets can be wirelessly transmitted from the baseband unit 140 to the plurality of STAs 110A-D via one or more of the APs 108A-I. In another embodiments, data packets can be transmitted from the application server 102 to the plurality of STAs 110A-D via one or more of the APs 108A-I via the network 104. Similarly, data packets can be transmitted from the plurality of STAs 110A-D to one or more APs 108A-I.

As described herein, a STA 110A-D can communicate with multiple APs 108A-I and an AP 108A-I can communicate with multiple STAs 110A-D in a single wireless stack (e.g., a single IEEE 820.11 protocol stack). For example, a STA 110A-D can authenticate simultaneously with multiple APs 108A-I (e.g., one or more of the APs 108A-I can individual or collectively authenticate the STA 110A-D upon request from the STA 110A-D) and decode any data packet that includes in a header or preamble a destination address that matches an address of the STA 110A-D, irrespective of the source address included in the header or preamble of the data packet (e.g., the STA 110A-D can decode any data packet that includes in a header or preamble a destination address that matches an address of the STA 110A-D whether or not the source address is the address of a particular AP 108A-I). Similarly, an AP 108A-I can decode any data packet that includes in a header or preamble a destination address that matches an address of the AP 108A-I or that matches a wildcard address associated with the AP 108A-I, irrespective of the source address included in the header of the data packet (e.g., the AP 108A-I can decode any data packet that includes in a header or preamble a destination address that matches an address of the AP 108A-I or that matches a wildcard address associated with the AP 108A-I whether or not the source address is the address of a particular STA 110A-D). For example, a wildcard address may be an address associated with multiple APs 108A-I rather than a unique address associated with just one AP 108A-I. As one illustrative example, the address associated with multiple APs 108A-I could be one or more addresses of one or more STAs 110A-D that has authenticated with some or all of the APs 108A-I. Thus, the wildcard address can be one or more addresses of one or more authenticated STAs 110A-D. As another example, an AP 108A-I can decode any data packet that includes in a header or preamble a source address that matches an address of one of a set of STAs 110A-D, such as an address of a STA 110A-D that has already authenticated with the AP 108A-I or another AP 108A-I that is part of the same wireless protocol stack as the AP 108A-I, irrespective of whether the destination address in the header or preamble matches an address of the AP 108A-I (e.g., the AP 108A-I can decode any data packet that includes in a header or preamble a source address that matches an address of one of a set of STAs 110A-D that has already authenticated with the AP 108A-I or another AP 108A-I that is part of the same wireless protocol stack whether or not the destination address is the address of the AP 108A-I itself).

For the purposes of illustration and not meant to be limiting, STA 110A communicates with APs 108A and 108B, STA 110B communicates with APs 108B and 108E, STA 110C communicates with APs 108D, 108E, and 108H, and STA 110D communicates with APs 108E and 108H. The STAs 110A-D and APs 108A-I, however, can communicate with other APs 108A-I and STAs 110A-D. Thus, unlike typical wireless network environments in which a basic service set (BSS) includes one AP assigned to one or more STAs, the multipoint environment 100 has no pre-defined AP 108A-I to which a STA 110A-D is associated. Rather, the AP 108A-I transmitting a data packet to a particular STA 110A-D can change on a packet-by-packet basis. For example, the AP 108D can transmit a first data packet to the STA 110C at a first time, the AP 108E can transmit a second data packet to the STA 110C at a second time, the AP 108H can transmit a third data packet to the STA 110C at a third time, the AP 108D can transmit a fourth data packet to the STA 110C at a fourth time, and so on. In fact, the AP 108A-I that transmits a data packet to the STA 110A-D can change without the STA 110A-D changing BSSs to which the STA 110A-D is associated—the STA 110A-D may remain in the same BSS using the same, single wireless stack while the AP 108A-I that transmits data packets to the STA 110A-D changes. Similarly, there may be no pre-defined STA 110A-D to which an AP 108A-I is associated. Rather, the STA 110A-D transmitting a data packet to a particular AP 108A-I can change on a packet-by-packet basis.

The AP controller 106 can be configured to select the AP 108A-I to transmit a data packet to a STA 110A-D. For example, the AP controller 106 can route traffic to one or more APs 108A-I for transmission to one or more STAs 110A-D based on downlink and/or uplink quality measurements. A downlink (DL) transmission generally refers to a communication from a network system (e.g., an AP) to a user terminal (e.g., a STA). An uplink (UL) transmission generally refers to a communication from the user terminal to the network system. The AP controller 106 may include one or more network interfaces to communicate via a wired and/or wireless connection (e.g., Ethernet, optical fiber, IEEE 802.11, etc.) with the baseband unit 140, the network 104, and/or the APs 108A-I. For example, the AP controller 106 may include one network interface that allows the AP controller 106 to communicate with each of the baseband unit 140, the network 104, and the APs 108A-I (where a switch coupled to the network interface or otherwise incorporated in the AP controller 106 may control to which component a transmission from the AP controller 106 is sent). As another example, the AP controller 106 may include a first network interface for communicating with the baseband unit 140, a second network interface for communicating with the network 104, and a third network interface for communicating with the APs 108A-I (where a switch coupled to the third network interface or otherwise incorporated in the AP controller 106 may control to which AP 108A-I a transmission from the AP controller 106 is sent). As another example, the AP controller 106 may include a first network interface for communicating with the baseband unit 140, a second network interface for communicating with the network 104, and one or more third network interfaces for communicating with the APs 108A-I (e.g., each AP 108A-I may receive communications from the AP controller 106 via a separate network interface, a first subset of the APs 108A-I may receive communications from the AP controller 106 via one network interface and a second subset of the APs 108A-I may receive communications from the AP controller 106 via another network interface, and/or any combination thereof). The AP controller 106 may also initiate serving AP switches by changing an AP 108A-I that is to serve a particular STA 110A-D. The AP controller 106 can implement a first approach and/or a second approach for serving an STA 110A-D for which the serving AP 108A-I has changed (e.g., which is referred to herein as an outgoing STA) in a manner that reduces service interruptions, as described herein.

In the multipoint environment 100, the baseband unit 140 and the application server 102 are optional. The base station functionality may be subdivided between the baseband unit 140 and/or the application server 102, the AP controller 106, and/or multiple remote radio units (RRUs) (e.g., APs 108A-I). An RRU may include multiple antennas, and one or more of the antennas may serve as a transmit-receive point (TRP). The RRU and/or a TRP may be referred to as a serving node, a base station, or an access point. In an embodiment in which the baseband unit 140 is present, the baseband unit 140 may be physically connected to the AP controller 106 and/or the RRUs, such as via an optical fiber connection. The baseband unit 140 and/or the AP controller 106 may provide operational details to an RRU to control transmission and reception of signals from the RRU along with control data and payload data to transmit. The RRU may provide data to the network received from STAs 110A-D within a service area associated with the RRU. An RRU can provide service to devices (e.g., STAs 110A-D) within a service area. For example, wireless downlink transmission service may be provided by an RRU to the service area to communicate data to one or more devices within the service area.

The application server 102 may store or otherwise access content that can be streamed or downloaded to the STAs 110A-D via the network 104 and the AP controller 106. For example, the content can include audio, images, video, documents, and/or any other type of media. As an illustrative example, the application server 102 can be a server that provides content for an application running on a STA 110A-D, such as a media streaming application (e.g., a music streaming application, a television and/or movie streaming application, etc.), a video chat application, a virtual reality application, an augmented reality application, and/or the like. The application server 102 can transmit the content in one or more packets to the AP controller 106 via the network 104, where the transmission may occur over a wireless connection, over a wired connection, or over a combination of wired and wireless connections. The application server 102 and/or the AP controller 106 may provide operational details to an RRU to control transmission and reception of signals from the RRU along with control data and payload data (e.g., content) to transmit.

The APs 108A-I may each have one or more transmit antennas that each support one or more digital basebands. In some embodiments, each AP 108A-I has the same number of transmit antennas. In other embodiments, some or all APs 108A-I have a different number of transmit antennas than other APs 108A-I. Thus, the APs 108A-I may collectively be capable of transmitting N spatial beams, where N is the product of the number of APs 108A-I in the multipoint environment 100 and the number of transmit antennas operated by a single AP 108A-I. Similarly, each AP 108A-I can have the same number or different number of receive antennas. The baseband unit 140, the AP controller 106, and/or the APs 108A-I can be collectively referred to herein as a “network system.”

Various standards and protocols may be included in the multipoint environment 100 to wirelessly communicate data between a base station (e.g., an AP 108) and a wireless communication device (e.g., a STA 110). Some wireless devices may communicate using an orthogonal frequency-division multiplexing (OFDM) digital modulation scheme via a physical layer. OFDM standards and protocols can include the third generation partnership project (3GPP) long term evolution (LTE), the Institute of Electrical and Electronics Engineers (IEEE) 802.16 standard (e.g., 802.16e, 802.16m), which may be known as WiMAX (Worldwide interoperability for Microwave Access), and the IEEE 802.11 standard, which may be known as Wi-Fi. In some systems, a radio access network (RAN) may include one or more base stations associated with one or more evolved NodeBs (also commonly denoted as enhanced NodeBs, eNodeBs, or eNBs), next generation NodeBs (gNBs), or any other suitable NodeBs (xNBs). In other embodiments, radio network controllers (RNCs) may be provided as the base stations. A base station provides a bridge between the wireless network and a core network such as the Internet. The base station may be included to facilitate exchange of data for the wireless communication devices of the wireless network.

The wireless communication device may be referred to as a station (STA) (e.g., for wireless communication devices that communicate using the IEEE 802.11 standard). The wireless communication device may also be referred to as a user equipment (UE) (e.g., for wireless communication devices that communicate in a RAN) or a wireless terminal (WT) (e.g., for wireless communication devices that run a content-based application). The STA may be a device used by a user such as a smartphone, a laptop, a tablet computer, cellular telephone, a wearable computing device such as a headset or smart glasses or a smart watch or an ear piece, one or more networked appliances (e.g., consumer networked appliances or industrial plant equipment), an industrial robot with connectivity, or a vehicle. In some implementations, the STA may include a sensor or other networked device configured to collect data and wirelessly provide the data to a device (e.g., server) connected to a core network such as the Internet. Such devices may be referred to as Internet of Things devices (IoT devices).

The network 104 may include any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The AP controller 106 can function as a router to route traffic between the baseband unit 140 and/or the application server 102 and the APs 108A-I. The AP controller 106 can implement a relatively small amount of buffering. This can contribute to the AP controller 106 routing data between the baseband unit 140 and/or the application server 102 and the APs 108A-I with low latency. The AP controller 106 can include any suitable hardware to implement the functionality described herein.

The APs 108A-I can be arranged as an array. All of the APs 108A-I can be connected to the AP controller 106. The APs 108A-I can be connected to the AP controller 106 via wired or wireless connections. Each AP 108A-I can buffer a relatively low amount of frames of data at a time. For example, an AP 108A can buffer 1 or 2 frames of data at a time in certain applications. The frames can be relatively big frames. For example, one frame can include 100 to 150 Internet protocol (IP) packets. The APs 108A-I are arranged to wirelessly communicate with STAs 110A-D. The APs 108A-I can communicate via any suitable wireless links, such as wireless local area network (WLAN) links. WLAN signals can have a shorter signal range than cellular signals. In some instances, the WLAN signals can have a range of about 300 feet or less. WLAN signals can have a range of about 150 feet or less in certain applications. An example of a WLAN link is a Wi-Fi link. The WLAN link can be implemented based on an IEEE 802.11 standard. The APs 108A-I are networking hardware devices that include any suitable physical hardware to implement the functionalities disclosed herein. Although APs are described with reference to certain embodiments for illustrative purposes, any suitable principles and advantages described with references to access points can be implemented with any other suitable serving nodes of a network system. Any suitable wireless link that meets latency and throughput specifications can be used. Wi-Fi links, millimeter wave (mmW) wireless area network (WAN) links, and fifth generation (5G) New Radio (NR) links in Frequency Range 2 (FR2) are examples of such suitable wireless links.

FIG. 1B is a schematic diagram illustrating a wireless network 150 that includes the baseband unit 140 according to an embodiment. In this embodiment, the APs 108A-I may operate as RRUs or serving nodes, and the baseband unit 140 and/or the AP controller 106 (not shown) may select users (e.g., STAs 110, STA 110 receive antennas, etc.) to be served by one or more APs 108A-I over one or more time slots and/or over one or more spatial dimensions.

As illustrated in FIG. 1B, the baseband unit 140 includes user data TX buffers 112, the scheduler control 114, a time/frequency resource allocation block 116, an active set and beam management block 118, a transceiver 120, a CSI computation block 122, an active set serving node update block 124, and the channel state data store 130. The baseband unit 140 can include any suitable physical hardware to implement the illustrated blocks. For example, the baseband unit 140 can include a processor and computer readable storage to implement any suitable blocks shown in FIG. 1B. The wireless network 150 also includes the APs 108A-I, one or more STAs 110, and/or the AP controller 106 (not shown). The wireless network 150 optionally includes other APs 108, not shown.

The baseband unit 140 and/or the AP controller 106 includes a scheduler that selects users to serve over one or more spatial dimensions over one or more time slots, selects APs 108A-I to serve user data, and schedules user data for wireless transmission between the APs 108A-I and STAs 110 over various spatial dimensions (e.g., spatial beams, channels, etc.). The scheduler can schedule DL data traffic, UL data traffic, or both. The scheduler can schedule data from any suitable number of APs 108 to any suitable number of UEs 110. The scheduler can include the user data queue TX buffers 112, the scheduler control 114, the time/frequency resource allocation block 116, the active set and beam management block 118, the CSI computation block 122, the active set serving node update block 124, and/or the channel state data store 130.

The transceiver 120 can provide a STA report received from the STA 110 to the scheduler. For example, the STA report can include spatial beam link strengths, spatial beam link quality, and/or other CSI suitable for allowing the scheduler to schedule DL data transmissions and/or to schedule UL data transmissions. The CSI computation block 122 can compute CSI data from data in the STA report. The active set serving node update block 124 can determine an updated active set for one or more STAs 110 based on updated link strength information provided by the STA(s) 110 (e.g., provided by the STA(s) 110 in response to receiving DL data traffic). In some instances, the active set serving node update block 124 can determine an updated active set for a subset of one or more antennas of a STA 110. The active set serving node update block 124 can use any suitable metrics disclosed herein to update an active set associated with a STA 110.

The transceiver 120 can also provide a beam visibility report received from the STA 110 and/or AP 108 to the scheduler. The beam visibility report can indicate which AP 108 has started transmitting UL data to a STA 110 in response to a blockage, obstruction, or other interference. For example, one AP 108 may have initially been serving a STA 110. Due to an obstruction or interference, however, another AP 108 may start serving the STA 110 instead. The beam visibility report can inform the scheduler of the new AP 108 that has started serving the STA 110 instead. The scheduler (e.g., the active set serving node update block 124) can use this information to determine an updated active set for the STA 110 (e.g., update information identifying the beam(s) serving the STA 110, which may now include the beam from the new AP 108 serving the STA 110, such that future DL transmissions to the STA 110 are completed using at least one of the identified beam(s)).

Alternatively or in addition, the beam visibility report can include information from a STA 110 indicating that the STA 110 cannot receive transmissions from a beam transmitted by an AP 108 originally assigned to serve the STA 110, but that the STA 110 can receive transmissions from a beam transmitted by another AP 108. The scheduler (e.g., the active set serving node update block 124) can use this information to determine an updated active set for the STA 110 (e.g., update information identifying the beam(s) serving the STA 110, which may now include the beam from the another AP 108 that the STA 110 can see, such that future DL transmissions to the STA 110 are completed using at least one of the identified beam(s)).

The updated active set data is provided to the scheduler control 114. The user data queue TX buffers 112 can provide user data (e.g., DL user data) to the scheduler control 114. The scheduler control 114 provides user data to the transceiver 120 and also provides instructions to the time/frequency resource allocation block 116. The time/frequency resource allocation block 116 can schedule timing and frequency of DL and/or UL data transmission from and/or to APs 108 (e.g., generate scheduling data), which can be forwarded to the APs 108 via the transceiver 120 and/or the AP controller 106. This can avoid timing conflicts and conflicts in the frequency domain. The active set and beam management block 118 can select APs 108 and/or specific spatial beams offered by these APs 108 for providing wireless transmission services to STAs 110, and create corresponding active sets for the STAs 110. The active set and beam management block 118 can group DL data transmissions and manage beamforming from the APs 108 to the STAs 110. The transceiver 120 provides data for transmission by the APs 108 to STAs 110.

As illustrated in FIG. 1B, the scheduler can cause a network system of the wireless network 150 to wirelessly transmit first user data to a first STA 110 across one or more spatial beams or spatial dimensions, to transmit second user data to a second STA 110 across one or more spatial beams or spatial dimensions, and so on. The scheduler can cause the transmissions of the first user data, the second user data, etc. to occur simultaneously and/or at different times. Moreover, the scheduler can cause a network system of the wireless network 150 to wirelessly transmit user data to any suitable number of STAs 110 across one or more spatial beams or spatial dimensions served by one or more APs 108.

### Data Routing and Serving AP Switching

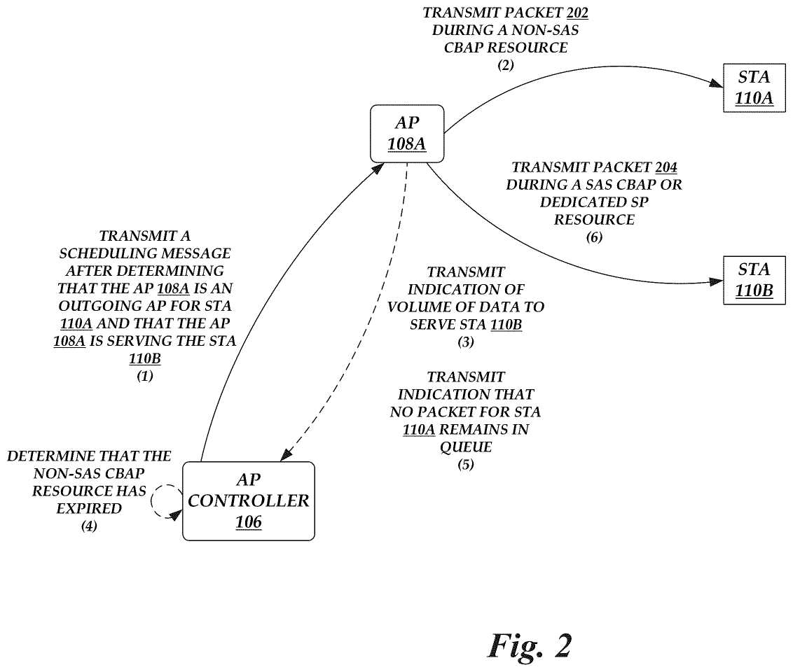

FIG. 2 is a block diagram of the multipoint environment 100 of FIG. 1A illustrating the operations performed by the components of the multipoint environment 100 to serve an outgoing STA 110A using a first approach according to an embodiment. As illustrated in FIG. 2, the AP 108A may initially be a serving AP for the STA 110A and for the STA 110B. The AP controller 106 may later generate and transmit a scheduling message to the AP 108A at (1) after the AP controller 106 has made the determination that the AP 108A is now an outgoing AP for the STA 110A, but is still the serving AP for the STA 110B. For example, the schedule generated by the AP controller 106 and transmitted to the AP 108A via the scheduling message may indicate that, going forward, the AP 108A will continue to serve the STA 110B using dedicated SP resources, but will no longer serve the STA 110A using dedicated SP resources. Note that the scheduling message may or may not explicitly indicate to the AP 108A about which STAs for which the AP 108A is the serving AP or outgoing AP, as that determination is made at the AP controller 106 and reflected in the resources assigned to the AP 108A even if not explicitly indicated to the AP 108A.

The scheduling message sent to AP 108A may assign AP 108A a non-SAS CBAP resource, with the ability to serve STA 110A exclusively. Thus, the AP 108A may be allowed to transmit any packets intended for the STA 110A (that remain in the transmission queues of the AP 108A) to the STA 110A. Thus, the AP 108A may transmit a packet 202 to the STA 110A during the non-SAS CBAP resource at (2). The AP 108A may further transmit any other packets to the STA 110A during the non-SAS CBAP resource that remain in the transmission queues of the AP 108A and that are intended for the STA 110A. The AP controller 106 can assign one common (e.g., overlapping in time) non-SAS CBAP resource to the AP 108A and/or any other outgoing APs to serve their respective outgoing STAs (or a subset of their respective outgoing STAs). Alternatively or in addition, the AP controller 106 can assign multiple non-SAS CBAP resources to the AP 108A and one or more other outgoing APs, where each non-SAS CBAP resource is to be used by one or more of the outgoing APs to serve their respective outgoing STAs (or a subset of their respective outgoing STAs). If multiple non-SAS CBAP resources are configured by the AP controller 106, each non-SAS CBAP resource may occur in succession (e.g., the non-SAS CBAP resources may be scheduled contiguously such that the non-SAS CBAP resources are collectively complete before a SAS CBAP resource or SP resource begins), or the multiple non-SAS CBAP resources may occur in a discontiguous manner.

The time duration for which the AP controller 106 provides non-SAS CBAP resources to an outgoing AP 108A, after making an AP switch for a STA 110A, can be configurable (e.g., by the AP controller 106). For example, the time duration may be an absolute time duration (e.g., in milliseconds), or a time duration in terms of multiples of some fixed quantity (e.g., a period of running the scheduler function at the AP controller 106). In either case, the AP controller 106 may be configured by the system administrator with a static value for this time duration (e.g., at AP controller 106 or system bring up or start up), or the AP controller 106 may be configured to dynamically optimize this time duration at run time (e.g., where the time duration changes based on current system conditions). For instance, the AP controller 106 may determine or anticipate the volume of data that an outgoing AP 108A may still need to serve to the outgoing STA(s) 110A, where this information may be available at the AP controller 106 based on existing (periodic or aperiodic) feedback from the AP 108A about the status of the AP data queues. The AP controller 106 can then determine the time duration based on the determined or anticipated volume of data that the outgoing AP 108A may need to serve to the outgoing STA(s) 110A. The AP controller 106 may also determine the time duration based on the number of outgoing STA(s) 110A that the outgoing AP 108A is required to serve and/or based on the number of other AP(s) 108 that are going to contend for the medium with the outgoing AP 108A. As an illustrative example, the AP 108A may optionally transmit to the AP controller 106 an indication of a volume of data to serve the STA 110B at (3), where the indication may include data that identifies the data packets remaining in the AP 108A data queues and/or the STAs 110A-D to which such packets are intended. The AP 108A may transmit the indication of the volume of data to serve the STA 110B any time before the AP controller 106 sends out a new scheduling message for a new time period. Here, if the AP controller 106 determines that the AP 108A will be an outgoing AP for STA 110B in a time period that follows a current time period, then the AP controller 106 may use the indication received from the AP 108A to set the time duration of non-SAS CBAP resources in the subsequent time period (e.g., the AP controller 106 may set the time duration to be at least equal to a time it may take to transmit the packets in the AP 108A queue that are intended for the STA 110A to the STA 110A).

Optionally, the AP controller 106 may set a timer that has a length matching a time duration of the non-SAS CBAP resource. When the timer reaches zero or the value of the non-SAS CBAP resource time duration, the AP controller 106 may determine that the non-SAS CBAP resource has expired at (4). Optionally, if before expiry of the timer (e.g., if before the non-SAS CBAP resource has expired) the AP controller 106 determines that the outgoing AP 108A has become an outgoing AP for another STA (e.g., a STA 110 other than STA 110A due to the other STA that was served by the AP 108A being reassigned to a new incoming AP), then the AP controller 106 may restart the timer for the existing non-SAS CBAP resource, and/or assign new or additional non-SAS CBAP resources to the AP 108A. The AP controller 106 also sends a new scheduling message to the AP 108A, indicating the updated set of CBAP resources (SAS and non-SAS) and an updated set of STAs to be served by the AP during the CBAP resource (SAS and non-SAS).

Alternatively or in addition, the AP 108A may transmit to the AP controller 106 at (5) an indication that no packet for STA 110A remains in the queue(s) of the AP 108A. For example, another method by which the AP controller 106 can determine the time duration may be based on an initial determination and subsequent feedback received from the outgoing AP 108A. In particular, the AP controller 106 may set an initial time duration of the non-SAS CBAP resource (e.g., based on one or more factors described herein). In response to receiving a schedule via a scheduling message with non-SAS CPAB resources where the (outgoing) AP 108A is allowed to serve only specific STA(s) (e.g., outgoing STA 110A), the outgoing AP 108A may subsequently indicate to the AP controller 106 when no more packets intended for these outgoing STA(s) (e.g., STA 110A) remain in the queue of the outgoing AP 108A. If the outgoing AP 108A provides this indication before expiry of the non-SAS CBAP resource, the AP controller 106 may cause the non-SAS CBAP resource to end early and send a new scheduling message to the AP(s) 108A-I earlier than initially scheduled. Otherwise, if the outgoing AP 108A does not provide this indication before expiry of the non-SAS CBAP resource (e.g., packets intended for outgoing STA 110A still remain in the queue of the outgoing AP 108A), then the non-SAS CBAP resource may expire at the conclusion of the time duration. It is to be noted that the determination of an AP 108A-I being an outgoing or incoming AP is made at the AP controller 106, and it causes the AP controller 106 to send out appropriate scheduling messages to the AP 108A-I. The AP 108A-I by itself may not be explicitly made aware of this determination, and may only see the impact of that determination via the scheduling message that the AP 108A-I receives.

After the time duration of the non-SAS CBAP resources assigned to an AP 108A has expired, the AP controller 106 may send a new scheduling message to the AP 108A such that the total CBAP resource becomes a SAS CBAP resource. It is to be noted that the determination of an AP 108A being an outgoing or incoming AP is made at the AP controller 106, and it causes the AP controller 106 to send out appropriate scheduling messages to the AP 108A. The AP 108A by itself may or may not be explicitly made aware of this determination, and may only see the impact of that determination via the scheduling message that the AP 108A receives. During the SAS CBAP resource, the AP 108A may be authorized to transmit packets to any STA. Thus, the AP 108A may transmit a packet 204 during the SAS CBAP resource or a dedicated SP resource to the STA 110B at (6), where the AP 108A can transmit the packet 204 during a SAS CBAP resource that overlaps in time with the non-SAS CBAP resource, during the SAS CBAP resource that transitioned from being a non-SAS CBAP resource, or during a dedicated SP resource.

At the same time at which the AP controller 106 assigns non-SAS CBAP resources to the outgoing AP 108A and/or other outgoing APs 108B-I, for APs 108B-I that are not outgoing APs, the AP controller 106 may continue to schedule SAS CBAP resources for such APs 108B-I. In some embodiments, the non-SAS CBAP resource assigned to outgoing APs may be exclusive to the outgoing APs (e.g., no non-outgoing APs may be scheduled to transmit during the time period occupied by the non-SAS CBAP resource). In other embodiments, the AP controller 106 may assign one or more outgoing APs to a non-SAS CBAP resource and one or more non-outgoing APs to a SAS CBAP resource, where the non-SAS CBAP resource and the SAS CBAP resource occupy the same time period.

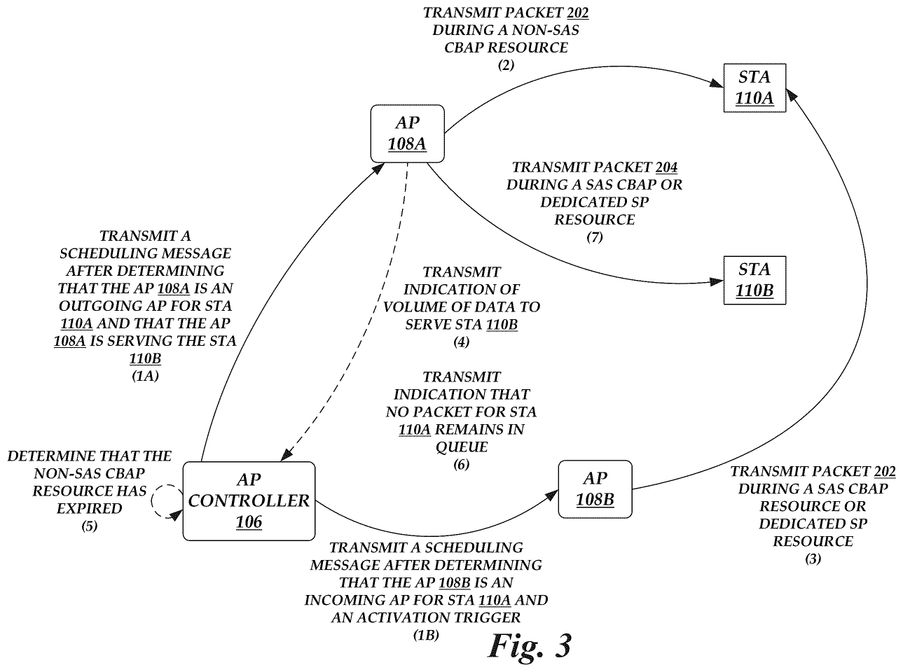

FIG. 3 is a block diagram of the multipoint environment 100 of FIG. 1A illustrating the operations performed by the components of the multipoint environment 100 to serve an outgoing STA 110A using a first approach and an immediate activation trigger message according to an embodiment. As illustrated in FIG. 3, the AP 108A may initially be a serving AP for the STA 110A and for the STA 110B. The AP controller 106 may later generate and transmit a scheduling message to the AP 108A at (1A) after the AP controller 106 has made the determination that the AP 108A is now an outgoing AP for the STA 110A, but is still the serving AP for the STA 110B. Before, during, and/or after transmitting the scheduling message to the AP 108A, the AP controller 106 may generate and transmit a scheduling message to the AP 108B at (1B) after the AP controller 106 has made the determination that the AP 108B is an incoming AP for the STA 110A and an activation trigger message at (1B). The scheduling message transmitted to the AP 108A and the scheduling message transmitted to the AP 108B may include the same or different schedules. For example, the schedule generated by the AP controller 106 and transmitted to the AP 108A via the scheduling message may indicate that, going forward, the AP 108A will continue to serve the STA 110B (but not STA 110A) using dedicated SP resources, and the schedule transmitted to the AP 108B via the scheduling message may indicate that the AP 108B will begin serving the STA 110A using dedicated SP resources. Note that the scheduling messages may or may not explicitly indicate to the APs 108A-B about which STAs for which the APs 108A-B are the serving APs, incoming APs, or outgoing APs, as that determination is made at the AP controller 106 and reflected in the resources assigned to the APs 108A-B even if not explicitly indicated to the APs 108A-B.

The scheduling message sent to AP 108A may assign AP 108A a non-SAS CBAP resource, with the ability to serve STA 110A exclusively, and the scheduling message sent to AP 108B may assign AP 108B only a SAS CBAP resource. The non-SAS CBAP resource may or may not overlap in time with the SAS CBAP resource. The non-SAS CBAP resource allows the AP 108A to transmit any packets intended for the STA 110A that remain in the transmission queue(s) of the AP 108A to the STA 110A. Thus, the AP 108A may transmit a packet 202 to the STA 110A during the non-SAS CBAP resource at (2). The AP 108A may further transmit any other packets to the STA 110A during the non-SAS CBAP resource that remain in the transmission queue of the AP 108A and that are intended for the STA 110A. The AP controller 106 can assign one common (e.g., overlapping in time) non-SAS CBAP resource to the AP 108A and/or any other outgoing APs to serve their respective outgoing STAs (or a subset of their respective outgoing STAs). Alternatively or in addition, the AP controller 106 can assign multiple non-SAS CBAP resources to the AP 108A and one or more other outgoing APs, where each non-SAS CBAP resource is to be used by one or more of the outgoing APs to serve their respective outgoing STAs (or a subset of their respective outgoing STAs). If multiple non-SAS CBAP resources are configured by the AP controller 106, each non-SAS CBAP resource may occur in succession (e.g., the non-SAS CBAP resources may be scheduled contiguously such that the non-SAS CBAP resources are collectively complete before a SAS CBAP resource or SP resource begins), or the multiple non-SAS CBAP resources may occur in a discontiguous manner.

Transmission of the activation trigger message upon the serving AP switch is referred to herein as bicasting. Bicasting may cause the incoming AP 108B to immediately begin transmitting (backup) packets to the outgoing STA 110A when the serving AP switch occurs. For example, the activation trigger message transmitted by the AP controller 106 may identify a packet, a range of packets, and/or a first packet in a sequence of packets that will be transmitted after the first packet (e.g., via sequence IDs) that the incoming AP 108B can begin transmitting to the outgoing STA 110A. Such packets may have already been transmitted by the AP controller 106 to the AP 108B as backup copies to be stored in a backup queue or other queue(s) of the AP 108B, such as when the primary copy of the packets were originally transmitted by the AP controller 106 to the AP 108A. The AP controller 106 may also indicate to the AP 108B (e.g., via a flag each packet's header) that these are backup copies, and the AP 108B then determines in response that the backup copy packets are not required to be sent by the AP 108B to the STA 110A unless explicitly instructed to by the AP controller 106 (e.g., through an activation trigger message from the AP controller 106 to the AP 108B), potentially at a time in the future. By sending an activation trigger message when the serving AP switch occurs, the AP controller 106 can guard against scenarios where the outgoing AP 108A is unsuccessful or delayed in sending some or all of the remaining packets in the queue of the outgoing AP 108A that are intended for the outgoing STA 110A. Thus, before, during, and/or after the AP 108A transmits packet 202 to the STA 110A, the AP 108B may transmit the packet 202 to the STA 110A during a SAS CBAP resource or dedicated SP resource at (3).

In this case, there may be duplication of packets sent to the outgoing STA 110A (e.g., both the outgoing AP108A and the incoming AP 108B may send the same packet 202 to the outgoing STA 110A). To prevent or minimize the effects of overhead due to excessive duplication, the AP controller 106 can limit the activation trigger to more recent packets. For example, the AP controller 106 could define the activation trigger to identify packets (e.g., by sequence ID) belonging to more recent content (e.g., the N most recent video frames, the N most recent slices of the M most recent video frames, the N most recent audio packets, the N most recent data packets, etc.).

The time duration for which the AP controller 106 provides non-SAS CBAP resources to an outgoing AP 108A, after making an AP switch for a STA 110A, can be configurable (e.g., by the AP controller 106). For example, the time duration may be an absolute time duration (e.g., in milliseconds), or a time duration in terms of multiples of some fixed quantity (e.g., a period of running the scheduler function at the AP controller 106). In either case, the AP controller 106 may be configured by the system administrator with a static value for this time duration (e.g., at AP controller 106 or system bring up or start up), or the AP controller 106 may be configured to dynamically optimize this time duration at run time (e.g., where the time duration changes based on current system conditions). For instance, the AP controller 106 may determine or anticipate the volume of data that an outgoing AP 108A may still need to serve to the outgoing STA(s) 110A, where this information may be available at the AP controller 106 based on existing (periodic or aperiodic) feedback from the AP 108A about the status of the AP data queues. The AP controller 106 can then determine the time duration based on the determined or anticipated volume of data that the outgoing AP 108A may need to serve to the outgoing STA(s) 110A. The AP controller 106 may also determine the time duration based on the number of outgoing STA(s) 110A that the outgoing AP 108A is required to serve and/or based on the number of other AP(s) 108 that are going to contend for the medium with the outgoing AP 108A. As an illustrative example, the AP 108A may optionally transmit to the AP controller 106 an indication of a volume of data to serve the STA 110B at (4), where the indication may include data that identifies the data packets remaining in the AP 108A data queues. The AP 108A may transmit the indication of the volume of data to serve the STA 110B any time before the AP controller 106 sends out a new scheduling message for a new time period. Here, if the AP controller 106 determines that the AP 108A will be an outgoing AP for STA 110B in a time period that follows a current time period, then the AP controller 106 may use the indication received from the AP 108A to set the time duration of non-SAS CBAP resources in the subsequent time period.

Optionally, the AP controller 106 may set a timer that has a length matching a time duration of the non-SAS CBAP resource. When the timer reaches zero or the value of the non-SAS CBAP resource time duration, the AP controller 106 may determine that the non-SAS CBAP resource has expired at (5). Optionally, if before expiry of the timer (e.g., if before the non-SAS CBAP resource has expired) the AP controller 106 determines that the outgoing AP 108A has become an outgoing AP for another STA (e.g., a STA 110 other than STA 110A due to the other STA that was served by the AP 108A being reassigned to a new incoming AP), then the AP controller 106 may restart the timer for the existing non-SAS CBAP resource, and/or assign new or additional non-SAS CBAP resources to the AP 108A. The AP controller 106 also sends a new scheduling message to the AP 108A, indicating the updated set of CBAP resources (SAS and non-SAS) and an updated set of STAs to be served by the AP during the CBAP resource (SAS and non-SAS).

Alternatively or in addition, the AP 108A may transmit to the AP controller 106 at (6) an indication that no packet for STA 110A remains in the queue of the AP 108A. For example, another method by which the AP controller 106 can determine the time duration may be based on an initial determination and subsequent feedback received from the outgoing AP 108A. In particular, the AP controller 106 may set an initial time duration of the non-SAS CBAP resource (e.g., based on one or more factors described herein). In response to receiving a schedule via a scheduling message with non-SAS CPAB resources where the (outgoing) AP 108A is allowed to serve only specific STA(s) (e.g., outgoing STA 110A), the outgoing AP 108A may subsequently indicate to the AP controller 106 when no more packets intended for these outgoing STA(s) (e.g., STA 110A) remain in the queue of the outgoing AP 108A. If the outgoing AP 108A provides this indication before expiry of the non-SAS CBAP resource, the AP controller 106 may cause the non-SAS CBAP resource to end early and send a new scheduling message to the AP(s) 108A-I earlier than initially scheduled. Otherwise, if the outgoing AP 108A does not provide this indication before expiry of the non-SAS CBAP resource (e.g., packets intended for outgoing STA 110A still remain in the queue of the outgoing AP 108A), then the non-SAS CBAP resource may expire at the conclusion of the time duration. It is to be noted that the determination of an AP 108A-I being an outgoing or incoming AP is made at the AP controller 106, and it causes the AP controller 106 to send out appropriate scheduling messages to the AP 108A-I. The AP 108A-I by itself may not be explicitly made aware of this determination, and may only see the impact of that determination via the scheduling message that the AP 108A-I receives.

After the time duration of the non-SAS CBAP resources assigned to an AP 108A has expired, the AP controller 106 may send a new scheduling message to the AP 108A such that the total CBAP resource becomes a SAS CBAP resource. It is to be noted that the determination of an AP 108A being an outgoing or incoming AP is made at the AP controller 106, and it causes the AP controller 106 to send out appropriate scheduling messages to the AP 108A. The AP 108A by itself may or may not be explicitly made aware of this determination, and may only see the impact of that determination via the scheduling message that the AP 108A receives. During the SAS CBAP resource, the AP 108A may be authorized to transmit packets to any STA. Thus, the AP 108A may transmit a packet 204 during the SAS CBAP resource or a dedicated SP resource to the STA 110B at (7), where the AP 108A can transmit the packet 204 during a SAS CBAP resource that overlaps in time with the non-SAS CBAP resource, during the SAS CBAP resource that transitioned from being a non-SAS CBAP resource, or during a dedicated SP resource.

At the same time at which the AP controller 106 assigns non-SAS CBAP resources to the outgoing AP 108A and/or other outgoing APs 108B-I, for APs 108B-I that are not outgoing APs, the AP controller 106 may continue to schedule SAS CBAP resources for such APs 108B-I. In some embodiments, the non-SAS CBAP resource assigned to outgoing APs may be exclusive to the outgoing APs (e.g., no non-outgoing APs may be scheduled to transmit during the time period occupied by the non-SAS CBAP resource). In other embodiments, the AP controller 106 may assign one or more outgoing APs to a non-SAS CBAP resource and one or more non-outgoing APs to a SAS CBAP resource, where the non-SAS CBAP resource and the SAS CBAP resource occupy the same or overlapping time period.

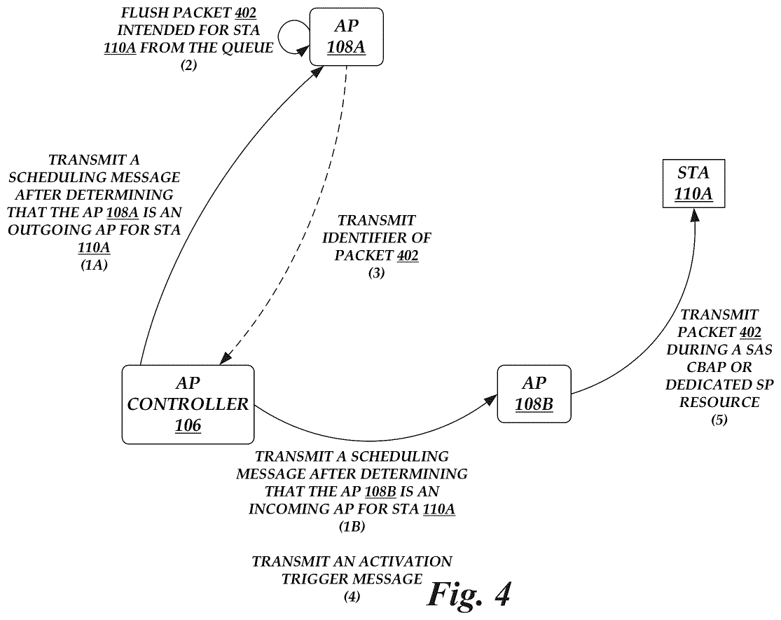

FIG. 4 is a block diagram of the multipoint environment 100 of FIG. 1A illustrating the operations performed by the components of the multipoint environment 100 to serve an outgoing STA 110A using a second approach according to an embodiment. As illustrated in FIG. 4, the AP 108A may initially be a serving AP for the STA 110A. The AP controller 106 may later generate and transmit a scheduling message to the AP 108A at (1A) after the AP controller 106 has made the determination that the AP 108A is now an outgoing AP for the STA 110A. Before, during, and/or after transmitting the scheduling message to the AP 108A, the AP controller 106 may generate and transmit a scheduling message to the AP 108B at (1B) after the AP controller 106 has made the determination that the AP 108B is an incoming AP for the STA 110A. The scheduling message transmitted to the AP 108A and the scheduling message transmitted to the AP 108B may include the same or different schedules. For example, the schedule generated by the AP controller 106 and transmitted to the AP 108B via the scheduling message may indicate that, going forward, the AP 108B will serve the STA 110A using dedicated SP resources. The schedule transmitted to the AP 108A via the scheduling message may further provide no dedicated SP resources to the outgoing AP 108A for serving the outgoing STA 110A. Rather, the schedule transmitted to the AP 108A via the scheduling message may indicate that all CBAP resources for the AP 108A are non-SAS and may not include the outgoing STA 110A in the list of STAs that the AP 108A is allowed to serve in the entire CBAP resource. Note that the scheduling messages may or may not explicitly indicate to the APs 108A-B about which STAs for which the APs 108A-B are the serving AP, the incoming AP, or the outgoing AP, as that determination is made at the AP controller 106 and reflected in the resources assigned to the APs 108A-B even if not explicitly indicated to the APs 108A-B.

Upon receiving the scheduling message and determining that the outgoing STA 110A is no longer servable even in any of the CBAP resources, the outgoing AP 108A may flush (e.g., drop from its queues) any remaining packets intended for outgoing STAs 110A that remain in the queues of the outgoing AP 108A (e.g., driver queue, USB queue, firmware queue, etc.). For example, the outgoing AP 108A may flush packet 402 that was intended for outgoing STA 110A from the queue(s) of the outgoing AP 108A at (2). The outgoing AP 108A may then transmit a message to the AP controller 106 at (3) that provides information on the flushed packet 402 (e.g., a sequence ID of the flushed packet 402, a sequence ID of some or all other flushed packets, a range of sequence IDs of some or all packets that are flushed, a lowest sequence ID of the flushed packet 402 or other flushed packets, etc.).

When the AP controller 106 initially routed the packets intended for the outgoing STA 110A to the outgoing AP 108A, the AP controller 106 may have routed a backup copy of one or more of these packets to one or more APs (including the AP 108B) that the AP controller 106 determined could potentially become serving APs for the outgoing STA 110A in the future. The AP controller 106 may also indicate to the AP 108B that these are backup copies (e.g., via an explicit flag in each packet's header, or via a message that the AP controller 106 sends to the AP 108 some or every time the AP controller 106 changes the role of the AP 108 for a given STA 110 between being a serving AP 108 or a backup AP 108 or neither), and the AP 108B then determines in response that the backup copy packets are not required to be sent by the AP 108B to the STA 110A unless explicitly instructed to by the AP controller 106 (e.g., through an activation trigger message from the AP controller 106 to the AP 108B), potentially at a time in the future. Thus, an incoming AP 108B for the outgoing STA 110A may have in a queue backup copies of one or more packets flushed by the outgoing AP 108A. Upon receiving the flushed packet information, the AP controller 106 can transmit an activation trigger message to the incoming AP 108B at (4) that indicates to the incoming AP 108B which packet(s) (from amongst the backup packets available in the data queue of the incoming AP 108 at that time instant) to transmit to the outgoing STA (e.g., packets with sequence IDs that are equal to or greater than the sequence ID of the first packet 402 flushed by the outgoing AP 108A, packets with sequence IDs matching some or all of the flushed packets, packets with sequence IDs that fall within the range of sequence IDs of flushed packets, etc.). In response, the incoming AP 108B may start transmitting the identified packet 402 to the outgoing STA 110A during a SAS CBAP or dedicated SP resource at (5) to ensure that the outgoing STA 110A does not miss any packets intended for the outgoing STA 110A.

As in the first approach, the time duration for which the AP controller 106 provides non-SAS CBAP resources to an outgoing AP 108A, after making the AP switch for a STA 110A, can be configurable (e.g., by the AP controller 106). For example, the time duration may be an absolute time duration (e.g., in milliseconds), or a time duration in terms of multiples of some fixed quantity (e.g., a period of running the scheduler function at the AP controller 106). In either case, the AP controller 106 may be configured by the system administrator with a static value for this time duration (e.g., at AP controller 106 or system bring up or start up), or the AP controller 106 may be configured to dynamically optimize this time duration at run time (e.g., where the time duration changes based on current system conditions). For instance, the AP controller 106 may determine or anticipate the volume of data that an outgoing AP 108A may need to flush, where this information may be available at the AP controller 106 based on existing (periodic or aperiodic) feedback from the AP 108A about the status of the AP 108A data queues. As an illustrative example, the AP 108A may have previously provided an indication of the packets remaining in the AP 108A queues prior to the AP controller 106 transmitting the scheduling message at (1), where the indication may have included an identification of the STAs 110A-D to which each packet is intended to be transmitted. The AP controller 106 may have used this information to determine the number of packets in the AP 108A queue that are intended for the STA 110A that the AP 108A may need to flush upon receipt of a new scheduling message, a time it may take for an incoming AP (e.g., AP 108B) to transmit such packets, and set the time duration to be equal to at least the time it may take for the incoming AP to transmit such packets, The AP controller 106 can then determine the time duration based on the determined or anticipated volume of data that the outgoing AP 108A may need to flush. As in the first approach, the AP controller 106 may also determine this time duration based on the number of outgoing STAs 110 for the outgoing AP 108A, and/or the number of other AP(s) 108 that are going to contend for the medium with the outgoing AP 108A. As in the first approach, the AP controller 106 may update this time duration based on any subsequent feedback from the outgoing AP 108A. After the time duration of the non-SAS CBAP resources assigned to an AP 108A has expired, the AP controller 106 may send a new scheduling message to the AP 108A such that the total CBAP resource becomes a SAS CBAP resource. It is to be noted that the determination of an AP 108A being an outgoing or incoming AP is made at the AP controller 106, and it causes the AP controller 106 to send out appropriate scheduling messages to the AP 108A. The AP 108A by itself may or may not be explicitly made aware of this determination, and may only see the impact of that determination via the scheduling message that the AP 108A receives.

As described herein, the AP controller 106 may set a timer to track the time that has passed since a non-SAS CBAP resource was assigned to an (outgoing) AP 108A. The AP controller 106 may determine that the non-SAS CBAP resource has expired once the timer reaches zero or the time duration length. Optionally, if before expiry of the timer (e.g., if before the non-SAS CBAP resource has expired) the AP controller 106 determines that the outgoing AP 108A has become an outgoing AP for another STA other than the STA 110A (e.g., due to another STA that was being served by the AP 108A being reassigned to a new incoming AP), then the AP controller 106 may restart the timer for the existing non-SAS CBAP resource, and/or assign new or additional non-SAS CBAP resources to the AP. The AP controller also sends a new scheduling message to the AP, indicating the updated set of CBAP resources (SAS and non-SAS) and an updated set of STAs to be served by the AP during the CBAP resource (SAS and non-SAS).

As in the first approach, at the same time at which the AP controller 106 assigns non-SAS CBAP resources for outgoing APs, for APs that are not outgoing APs, the AP controller 106 may continue to schedule SAS CBAP resources for such APs. Thus, the AP 108B may transmit the packet 402 during a SAS CBAP resource. In some embodiments, the non-SAS CBAP resource assigned to outgoing APs may be exclusive to the outgoing APs (e.g., no non-outgoing APs may be scheduled to transmit during the time period occupied by the non-SAS CBAP resource). In other embodiments, the AP controller 106 may assign one or more outgoing APs to a non-SAS CBAP resource and one or more non-outgoing APs to a SAS CBAP resource, where the non-SAS CBAP resource and the SAS CBAP resource occupy the same or overlapping time period.

While the data flush and subsequent activation trigger approach has been described above with respect to the second approach, the data flush and subsequent activation trigger approach can be applied to the first approach as well. Specifically, in the first approach, when the AP controller 106 sends a new scheduling message to the outgoing AP (providing the outgoing AP with non-SAS CBAP resource(s) to serve the outgoing STA(s)), the AP controller 106 can also explicitly instruct (either through the scheduling message, or a separate message) the outgoing AP to flush the remaining packets in its data queues meant for the outgoing STA(s). This strategy minimizes the data packets that the outgoing AP still needs to send to the outgoing STA(s), while still providing the outgoing AP a (non-SAS) CBAP resource to serve the outgoing STA(s) with any packets that could not actually be flushed, e.g., because those packets were already beyond a point in the data transmission pipeline where they could be flushed. As in the second approach, the outgoing AP then transmits a message to the AP controller 106 that provides information on the flushed packet ID(s), which the AP controller 106 uses to send an activation trigger message to the incoming AP(s) for the STA(s).

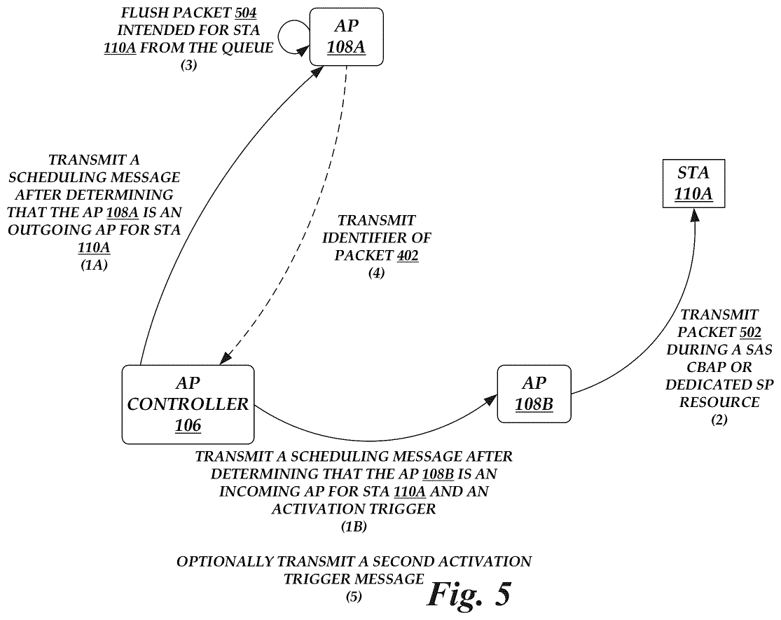

FIG. 5 is a block diagram of the multipoint environment 100 of FIG. 1A illustrating the operations performed by the components of the multipoint environment 100 to serve an outgoing STA 110A using a second approach and an activation trigger message according to an embodiment. As illustrated in FIG. 5, the AP 108A may initially be a serving AP for the STA 110A. The AP controller 106 may later generate and transmit a scheduling message to the AP 108A at (1A) after the AP controller 106 has made the determination that the AP 108A is now an outgoing AP for the STA 110A. Before, during, and/or after transmitting the scheduling message to the AP 108A, the AP controller 106 may generate and transmit a scheduling message to the AP 108B at (1B) after the AP controller 106 has made the determination that the AP 108B is an incoming AP for the STA 110A and an activation trigger. The scheduling message transmitted to the AP 108A and the scheduling message transmitted to the AP 108B may include the same or different schedules. For example, the schedule generated by the AP controller 106 and transmitted to the AP 108B via the scheduling message may indicate that, going forward, the AP 108B will serve the STA 110A using dedicated SP resources. The schedule transmitted to the AP 108A via the scheduling message may further provide no dedicated SP resources to the outgoing AP 108A for serving the outgoing STA 110A. Rather, the schedule transmitted to the AP 108A via the scheduling message may indicate that all CBAP resources for the AP 108A are non-SAS and may not include the outgoing STA 110A in the list of STAs that the AP 108A is allowed to serve in the entire CBAP resource. Note that the scheduling messages may or may not explicitly indicate to the APs 108A-B about which STAs for which the APs 108A-B are the serving AP, the incoming AP, or the outgoing AP, as that determination is made at the AP controller 106 and reflected in the resources assigned to the APs 108A-B even if not explicitly indicated to the APs 108A-B.

Bicasting may cause the incoming AP 108B to immediately begin transmitting (backup) packets to the outgoing STA 110A when the serving AP switch occurs. For example, the activation trigger message transmitted by the AP controller 106 may identify a packet, a range of packets, and/or a first packet in a sequence of packets that will be transmitted after the first packet (e.g., via sequence IDs) that the incoming AP 108B can begin transmitting to the outgoing STA 110A. Such packets may have already been transmitted by the AP controller 106 to the AP 108B as backup copies to be stored in a backup queue or other queue(s) of the AP 108B, such as when the primary copy of the packets were originally transmitted by the AP controller 106 to the AP 108A. The AP controller 106 may also indicate to the AP 108B (e.g., via a flag each packet's header) that these are backup copies, and the AP 108B then determines in response that the backup copy packets are not required to be sent by the AP 108B to the STA 110A unless explicitly instructed to by the AP controller 106 (e.g., through an activation trigger message from the AP controller 106 to the AP 108B), potentially at a time in the future. By sending an activation trigger message when the serving AP switch occurs, the AP controller 106 can guard against scenarios where the outgoing AP 108A is unsuccessful or delayed in sending some or all of the remaining packets in the queue of the outgoing AP 108A that are intended for the outgoing STA 110A. Thus, the AP 108B can transmit packet 502 to the STA 110A during a SAS CBAP or dedicated SP resource at (2).

Before, during, and/or after the AP 108B transmits the packet 502, the outgoing AP 108A may flush (e.g., drop from its queues) any remaining packets intended for outgoing STAs 110A that remain in the queues of the outgoing AP 108A (e.g., driver queue, USB queue, firmware queue, etc.). For example, the outgoing AP 108A may flush packet 504 that was intended for outgoing STA 110A from the queue(s) of the outgoing AP 108A at (3). The outgoing AP 108A may then transmit a message to the AP controller 106 at (4) that provides information on the flushed packet 504 (e.g., a sequence ID of the flushed packet 504, a sequence ID of some or all other flushed packets, a range of sequence IDs of some or all packets that are flushed, etc.).

If the AP controller 106 transmits an activation trigger message to the incoming AP 108B when the serving AP switch occurs, the AP controller 106 may transmit one or more additional activation trigger messages at a future time. For example, the AP controller 106 may receive the indication of packets flushed by the outgoing AP 108A after the AP controller 106 transmits the initial activation trigger message. As a result, the AP controller 106 optionally transmits a second activation trigger message (and a third, fourth, fifth, etc. activation trigger message) to the incoming AP 108B at (5) to ensure that the incoming AP 108B transmits backup copies of the indicated packets to the outgoing STA 110A if the incoming AP 108B has not already done so. As an illustrative example, the AP 108B has already transmitted the packet 502 to the STA 110A, which may have been flushed by the AP 108A. However, the AP 108A may have flushed other packets that have not yet been transmitted by the AP 108B to the STA 110A, such as the packet 504. To prevent unnecessary activation trigger messages, the AP controller 106 can apply a filter to determine if a new trigger needs to be sent to the AP 108B. Specifically, the AP controller 106 can determine a time that the last activation trigger message (e.g., the activation trigger message at (1B)) was sent to the incoming AP 108B for a particular outgoing STA 110A. If the last activation trigger message was sent within a threshold time period of a current time and was directed to a particular packet (e.g., a packet with a particular sequence ID, such as the packet 504), the AP controller 106 can send a new, second activation trigger message to the same incoming AP 108B for the same outgoing STA 110A if the sequence ID of the packet 504 identified in the second activation trigger message (e.g., the sequence ID of the packet 504 identified by the outgoing AP 108A to the AP controller 106 after the queue flush concludes) is less than the sequence ID of the packet identified in the last activation trigger message. Otherwise, if the last activation trigger message was sent earlier than a threshold time period before a current time, then the AP controller 106 can send a new, second activation trigger message to the same incoming AP 108B for the same outgoing STA 110A. The second activation trigger message may indicate which packet(s) to transmit to the outgoing STA 110A (e.g., packets with sequence IDs that are equal to or greater than the sequence ID of the first packet flushed by the outgoing AP 108A, packets with sequence IDs matching some or all of the flushed packets, packets with sequence IDs that fall within the range of sequence IDs of flushed packets, etc.). Here, if the AP controller 106 transmits the second activation trigger message, transmission of the second activation trigger message may cause the AP 108B to transmit the packet 504 to the STA 110A during the SAS CBAP resource or a dedicated SP resource.

While the filter for the activation trigger messages is motivated by a specific scenario above (e.g., when AP controller 106 sends an activation trigger message to the incoming AP 108B at the time of AP switch, and then receives a follow-up flushed packet information from the outgoing AP 108A), the filter can be applied in general. In other words, the filtering can be done at all times, whenever a determination needs to be made by the AP controller 106 whether the AP controller 106 should send a new activation trigger message to an AP 108B or not, regardless of the circumstances that caused this determination to be made.

As described herein, the time duration for which the AP controller 106 provides non-SAS CBAP resources to an outgoing AP 108A, after making the AP switch for a STA 110A, can be configurable (e.g., by the AP controller 106). For example, the time duration may be an absolute time duration (e.g., in milliseconds), or a time duration in terms of multiples of some fixed quantity (e.g., a period of running the scheduler function at the AP controller 106). In either case, the AP controller 106 may be configured by the system administrator with a static value for this time duration (e.g., at AP controller 106 or system bring up or start up), or the AP controller 106 may be configured to dynamically optimize this time duration at run time (e.g., where the time duration changes based on current system conditions). For instance, the AP controller 106 may determine or anticipate the volume of data that an outgoing AP 108A may need to flush, where this information may be available at the AP controller 106 based on existing (periodic or aperiodic) feedback from the AP 108A about the status of the AP 108A data queues. As an illustrative example, the AP 108A may have previously provided an indication of the packets remaining in the AP 108A queues prior to the AP controller 106 transmitting the scheduling message at (1), where the indication may have included an identification of the STAs 110A-D to which each packet is intended to be transmitted. The AP controller 106 may have used this information to determine the number of packets in the AP 108A queue that are intended for the STA 110A that the AP 108A may need to flush upon receipt of a new scheduling message, a time it may take for an incoming AP (e.g., AP 108B) to transmit such packets, and set the time duration to be equal to at least the time it may take for the incoming AP to transmit such packets, The AP controller 106 can then determine the time duration based on the determined or anticipated volume of data that the outgoing AP 108A may need to flush. As in the first approach, the AP controller 106 may update this time duration based on any subsequent feedback from the outgoing AP 108A. After the time duration of the non-SAS CBAP resources assigned to an AP 108A has expired, the AP controller 106 may send a new scheduling message to the AP 108A such that the total CBAP resource becomes a SAS CBAP resource. It is to be noted that the determination of an AP 108A being an outgoing or incoming AP is made at the AP controller 106, and it causes the AP controller 106 to send out appropriate scheduling messages to the AP 108A. The AP 108A by itself may or may not be explicitly made aware of this determination, and may only see the impact of that determination via the scheduling message that the AP 108A receives.

As described herein, the AP controller 106 may set a timer to track the time that has passed since a non-SAS CBAP resource was assigned to an (outgoing) AP 108A. The AP controller 106 may determine that the non-SAS CBAP resource has expired once the timer reaches zero or the time duration length. Optionally, if before expiry of the timer (e.g., if before the non-SAS CBAP resource has expired) the AP controller 106 determines that the outgoing AP 108A has become an outgoing AP for another STA other than the STA 110A (e.g., due to another STA that was being served by the AP 108A being reassigned to a new incoming AP), then the AP controller 106 may restart the timer for the existing non-SAS CBAP resource, and/or assign new or additional non-SAS CBAP resources to the AP. The AP controller also sends a new scheduling message to the AP, indicating the updated set of CBAP resources (SAS and non-SAS) and an updated set of STAs to be served by the AP during the CBAP resource (SAS and non-SAS).

As described herein, at the same time at which the AP controller 106 assigns non-SAS CBAP resources for outgoing APs, for APs that are not outgoing APs, the AP controller 106 may continue to schedule SAS CBAP resources for such APs. Thus, the AP 108B may transmit the packet 402 during a SAS CBAP resource. In some embodiments, the non-SAS CBAP resource assigned to outgoing APs may be exclusive to the outgoing APs (e.g., no non-outgoing APs may be scheduled to transmit during the time period occupied by the non-SAS CBAP resource). In other embodiments, the AP controller 106 may assign one or more outgoing APs to a non-SAS CBAP resource and one or more non-outgoing APs to a SAS CBAP resource, where the non-SAS CBAP resource and the SAS CBAP resource occupy the same or overlapping time period.

In some embodiments, the AP controller 106 may statically (e.g., at system bring up or start up) be configured to either pursue the first approach or the second approach and continue to implement the selected approach each time a new serving AP switch occurs. In other embodiments, the AP controller 106 can be configured to dynamically select either the first approach or the second approach when a new serving AP switch occurs. For example, the AP controller 106 may evaluate the channel conditions between the outgoing AP 108A-I and the outgoing STA 110A-D. If the SNR of the channel is above a threshold SNR level, then the AP controller 106 may implement the first approach. However, if the SNR of the channel is below the threshold SNR level, then the AP controller 106 may implement the second approach. The decision could also be influenced by the information the AP controller 106 may have about the status of the queues at the AP 108A-I, such as the volume of the data the (outgoing) AP 108A-I still has in its queues for the (outgoing) STAs 110A-D, and/or by the number of outgoing STA(s) 110A-D, and/or the number of other AP(s) 108A-I that are going to contend for the medium with the outgoing AP 108A-I.

While the preceding embodiments describe approaches to configure non-SAS CBAPs for the outgoing APs 108A-I, in another embodiment, the AP controller 106 may configure the incoming AP(s) 106 with non-SAS CBAP resources, and specifically restrict the incoming AP(s) 108A-I to serve only their respective incoming STA(s) 110A-D during such non-SAS CBAP resources. This helps provide additional (quasi-dedicated) resources to the incoming AP(s) 108A-I to serve the incoming STA(s) 110A-D, in addition to dedicated resources provided in the scheduled periods (SPs). This can be especially useful when the bicasting approach is used by the AP controller 106, as the AP controller 106 explicitly triggers the incoming AP 108A-I to also send backup data to the STA 110A-D, in addition to any new (non-backup) data that the AP controller 106 starts routing to the incoming AP 108A-I at the time of the AP switch.

The decision to provide non-SAS CBAP resources to outgoing and/or incoming APs 108A-I may be independent. For instance, the AP controller 106 may be statically configured (e.g., at system bring up or start up) to provide non-SAS CBAP resources to outgoing APs 108A-I only and not to incoming APs 108A-I, or vice-versa, or to both. The AP controller 106 may also be configured to make such decisions dynamically depending on prevailing conditions.

As in previous embodiments of non-SAS CBAP resources for outgoing APs 108A-I, the time duration for which the AP controller 106 may configure an incoming AP 108A-I with non-SAS CBAP resources can be configurable, either set to a certain value statically (at system bring up or start up), or can be configured to be dynamically adjustable based on prevailing conditions.

### First Approach Routine

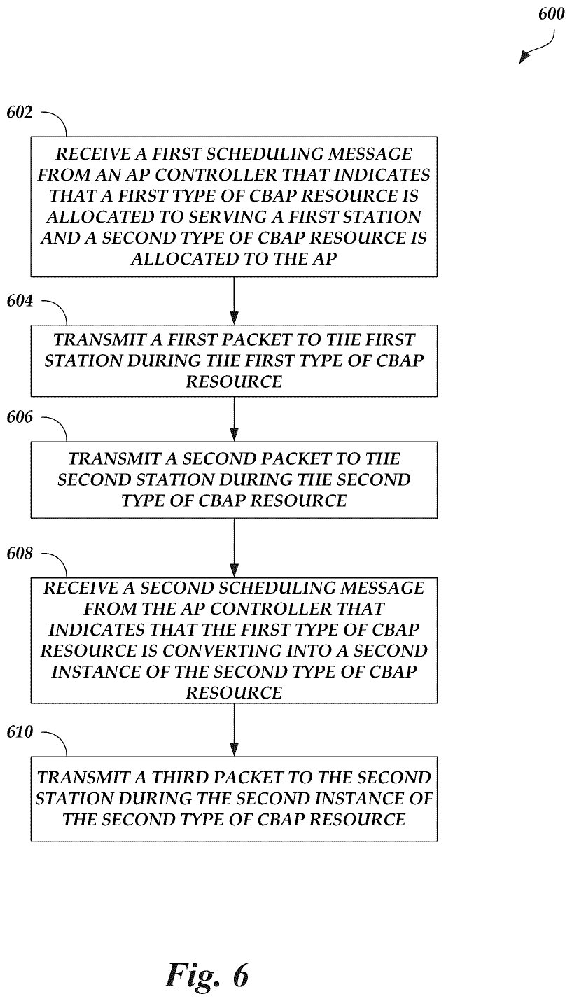

FIG. 6 is a flow diagram depicting an outgoing STA serving routine 600 illustratively implemented by an AP, according to one embodiment. As an example, an AP 108A-I can be configured to execute the outgoing STA serving routine 600. The outgoing STA serving routine 600 begins at block 602 and may implement a first approach for serving outgoing STAs.

At block 602, a first scheduling message from an AP controller is received that indicates that a first type of CBAP resource is allocated to serving a first station and a second type of CBAP resource is allocated to the AP. For example, the AP that receives the first scheduling message may be an outgoing AP for the first station and may continue to serve a second station. The first type of CBAP resource may be a non-SAS CBAP resource, and the second type of CBAP resource may be a SAS CBAP resource. The first and second types of CBAP resources may overlap in time.

At block 604, a first packet is transmitted to the first station during the first type of CBAP resource. For example, the first packet may be a packet that was stored in the queue of the outgoing AP and that was intended for the first station.

At block 606, a second packet is transmitted to the second station during the second type of CBAP resource. The second packet can be transmitted before, during, and/or after transmission of the first packet.

At block 608, a second scheduling message from the AP controller is received that indicates that a second type of CBAP resource is converting into a second instance of the second type of CBAP resource. The second instance of the second type of CBAP resource may be a SAS CBAP resource in which the AP can serve a second station. The AP controller 106 may transmit the second scheduling message upon expiry of a timer associated with a time duration of the non-SAS CBAP resource. In further embodiments, the timer may be reset one or more times before expiring, such as if the outgoing AP becomes an outgoing AP for another station other than the first station. The second type of CBAP resource (e.g., a first instance of the second type of CBAP resource) originally allocated in the first scheduling message may or may not overlap in time with the second instance of the second type of CBAP resource.

At block 610, a third packet is transmitted to the second station during the second instance of the second type of CBAP resource. For example, the second scheduling message received by the AP may indicate that the AP is allowed to transmit packets to any stations during the SAS CBAP resource. The second instance of the second type of CBAP resource may follow the first type of CBAP resource. After the third packet is transmitted, the outgoing STA serving routine 600 ends.

### Second Approach Routine

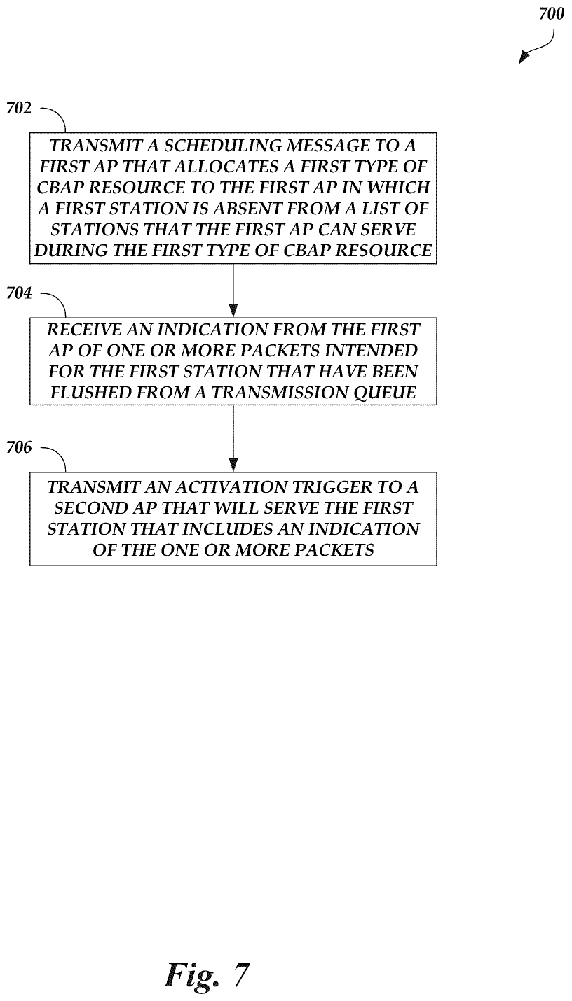

FIG. 7 is a flow diagram depicting an outgoing STA serving routine 700 illustratively implemented by an AP controller, according to one embodiment. As an example, the AP controller 106 can be configured to execute the outgoing STA serving routine 700. The outgoing STA serving routine 700 begins at block 702 and may implement a second approach for serving outgoing STAs.

At block 702, a scheduling message is transmitted to a first AP that allocates a first type of CBAP resource to the first AP in which a first station is absent from a list of stations that the first AP can serve during the first type of CBAP resource. For example, the first type of CBAP resource may be a non-SAS CBAP resource. Thus, the first AP may be an outgoing AP and the first station may be an outgoing station.

At block 704, an indication is received from the first AP of one or more packets intended for the first station that have been flushed from a transmission queue of the first AP. For example, the first AP may flush the packets intended for the first station in response to receiving the scheduling message in which no first type of CBAP resource (or any CBAP resource) is allocated to serving the first station. Thus, the first AP may not transmit any more packets to the first station once the first AP receives and applies this scheduling message.

At block 706, an activation trigger message is transmitted to a second AP that will serve the first station (e.g., as an incoming AP) that includes an indication of the one or more packets. For example, the activation trigger message may identify the packets flushed by the outgoing first AP so that the incoming second AP can send the flushed packets (e.g., backup copies of the flushed packets stored in a queue of the incoming second AP) to the first station to avoid service disruptions. After the activation trigger message is transmitted, the outgoing STA serving routine 700 ends.

### Example Baseband Unit and Remote Radio Unit

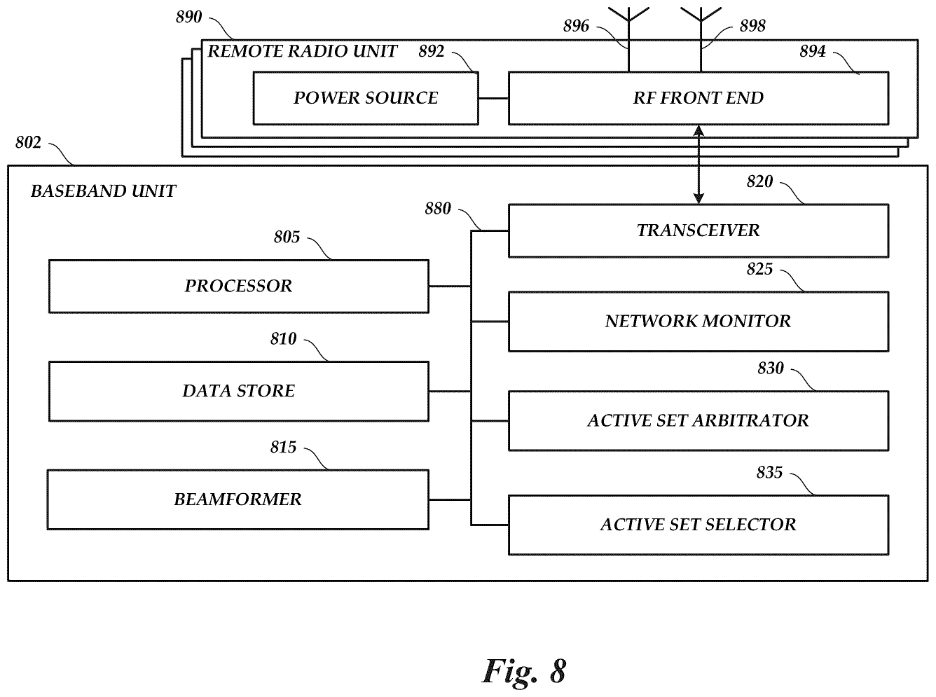

FIG. 8 is a block diagram illustrating an example baseband unit 802 and remote radio unit 890 according to an embodiment. The baseband unit 802 may be coupled with at least one remote radio unit 890. The remote radio unit 890 may include at least a first antenna 896 and a second antenna 898 for MIMO wireless communications. Any antenna disclosed herein, such as the antenna 896 or the antenna 898, can be referred to as antenna element. The first antenna 896 and the second antenna 898 may be coupled with a RF front end 894. The RF front end 894 may process signals received via the first antenna 896 and the second antenna 898. Part of processing a signal may include transmitting the signal to a transceiver 820 included in the BBU 802.

A processor 805 may receive signals received by the transceiver 820. The processor 805 may be configured to determine a type of the signal. For example, if the signal includes a request for connection services, the processor 805 may provide the signal to an active set selector 835. The active set selector 835 may be configured to identify an active set of serving nodes to provide the requested downlink data transmission service. The active set selector 835 can identify the active set for a STA based on information associated with the STA. Alternatively or additionally, the active set selector 835 can identify the active set for a STA based on information associated with one or more other STAs. In some instances, the active set selector 835 can identify specific spatial beam(s) selected to serve a STA. The BBU 802 may include a network monitor 825 to detect characteristics of the network such as the number of STAs served by each RRU, network data transmission load, and/or the like. The active set selector 835 may receive the network characteristics from the network monitor 825 as a factor considered when selecting spatial beam(s) to serve a STA and/or identifying an active set for a STA.

A beamformer 815 may be included in the BBU 802 to further identify parameters for the serving nodes (e.g., RRUs) included in an active set. The parameters may include one or more of transmission mode, time, frequency, power, beamforming matrix, tone allocation, or channel rank. The beamformer 815 may determine optimal parameters for RRUs coupled with the BBU 802 that facilitate a network-wide optimization of downlink data transmissions. In some implementations, the active set selector 835 determines an active set for a STA based, in part, on information provided by the STA. In other implementations, a UE may provide a requested active set. The BBU 802 may include an active set arbitrator 830 to reconcile a requested active set with an active set selected by the active set selector 835. The active set arbitrator 830 may compare a requested set of serving nodes to the serving nodes identified by the active set selector 835. The comparison may include ordering the serving nodes according to the STA recommendation. In some implementations, the active set arbitrator 830 may provide a message to the STA indicating confirmation or other assessment for a requested active set. For example, if the STA requested nodes A and B but the BBU 802 identified only B in the active set, the message may include a code indicating a partial match for the active set. Other status codes may be included to facilitate efficient communication and assessment of requested active sets. The active set arbitrator 830 may additionally or alternatively compare a requested transmission mode to the transmission mode identified by the active set selector 835 or other element of the BBU 802.

The BBU 802 may include a data store 810. The data store 810 may include instructions that can be executed by the processor 805 to implement the features described herein. In some implementations, the data store 810 may retain active sets or other scheduling information assigned to STAs served by the BBU 802 and/or channel state information. The data store 810 may be indexed by STA identifier and/or RRU identifier. This can expedite identification of previously communicated scheduling information for the STA and for monitoring network conditions (e.g., number of STAs allocated to an RRU or antenna element of an RRU).

Several elements included in the BBU 802 may be coupled by a bus 880. The bus 880 can be a data bus, communication bus, other bus, or any suitable combination thereof to enable the various components of the BBU 802 to exchange information.

In addition to providing the scheduling information to the STA, the scheduling information may be used to configure the RRU 890. The configuration may include adjusting the first antenna 896 such as by frequency modulation, time modulation, altering transmission power from a power source 892, or adjusting direction, tone allocation, or beamforming of the transmission.

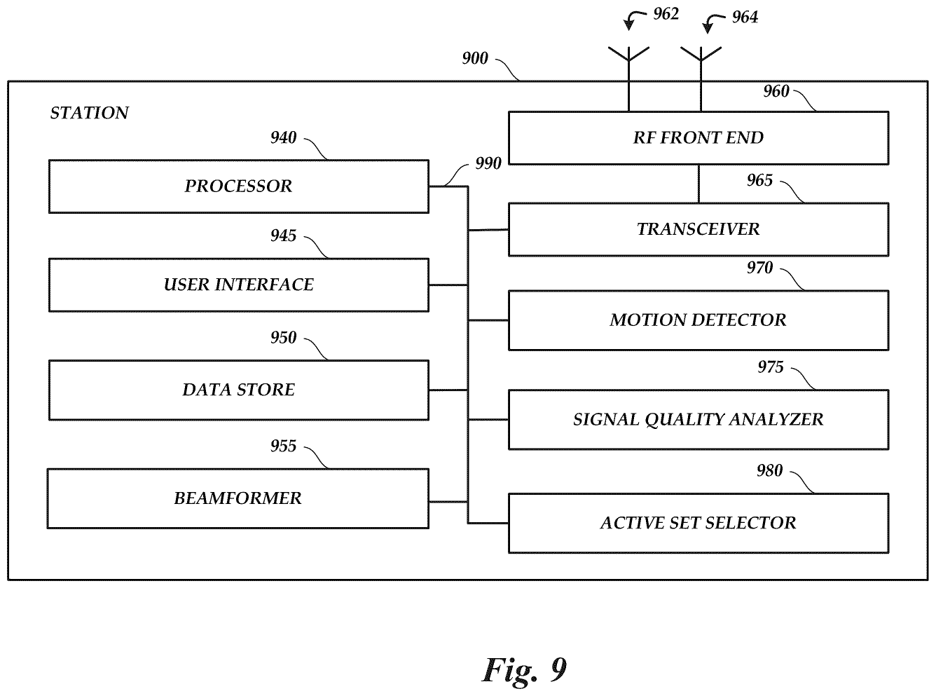

As discussed above, a variety of different STAs can wirelessly communicate with serving nodes in a cooperative MIMO network. An example STA will be discussed with reference to FIG. 9.

### Example STA

FIG. 9 is a schematic block diagram of an example STA 900 according to an embodiment. The STA 900 is configured for wirelessly communicating with a base station in a cooperative MIMO network. As illustrated in FIG. 9, the STA 900 includes a processor 940, a user interface 945, a data store 950, a beamformer 955, antennas 962 and 964, a transceiver 965, a motion detector 970, a signal quality analyzer 975, and an active set selector 980. Some other STAs can include additional elements and/or a subset of the elements illustrated in FIG. 9.

The STA 900 includes a plurality of antennas 962 and 964. Any suitable number of antennas can be included for wireless communication. The STA 900 can include one or more arrays of antennas. A radio frequency (RF) front end 960 can process RF signals received via the antennas 962 and 964. The RF front end can also provide RF signals to the antennas 962 and 964 for transmission. The transceiver 965 includes a transmitter and a receiver. The transceiver 965 can provide processing for transmitting and receiving RF signals associated with the antennas 962 and 964. For example, upon receiving active set data, the processor 940 can configure the transceiver 965 (e.g., receiver) to receive DL data associated with the spatial beam(s) identified in the active set data as being selected to serve the STA 900.

The processor 940 is in communication with the transceiver 965. The processor 940 is implemented by physical hardware arranged to perform specific operations to implement functionality related to determining a link strength of spatial beams over which beam pilots and/or user data are transmitted. The processor 940 can determine the link strength, identify a spatial beam that provides the best link strength, and/or generate one or more messages to report the link strength to a serving node in accordance with any suitable principles and advantages disclosed herein. The processor 940 can cause active set and neighbor set data to be stored and updated. The processor 940 can perform any other suitable processing for the STA 900.

The processor 940 can be in communication with the motion detector 970 and the signal quality analyzer 975. Accordingly, the processor 940 can receive and process information associated with conditions of the STA 900. The motion detector 970 can include any suitable hardware arranged to detect mobility information associated with the STA 900. The signal quality analyzer 975 can analyze the quality of signals received and/or transmitted by the antennas 962 and 964. This can provide information associated with a spatial channel condition of the STA 900. The information associated with conditions of the STA 900 can be provided to the processor 940 for providing to the serving node(s). In some instances, some or all of the functionality of the motion detector 970 and/or the signal quality analyzer can be implemented by the processor 940.

The active set selector 980 is optional and can identify a desired active set of one or more serving nodes. The active set selector 980 can select the desired active set based on data associated with one or more of: one or more serving nodes in the active set, one or more serving nodes in the neighbor set, mobility data associated with the UE 900, a spatial channel condition associated with the STA 900, the link strength and/or the link quality of one or more spatial beams served by one or more serving nodes, or one or more characteristics of the STA 900. The active set selector 980 can optionally execute the active set management scheme to identify a desired active set. The active set selector 980 can cause the processor 940 to generate a message for transmission to a serving node and/or a BBU to request that a selected spatial beam (or selected spatial beams) be added to an active set for the STA 900 (e.g., request that a selected spatial beam, which may be different than the spatial beam(s) already included in an active set for the STA 900, be included in an updated active set for the STA 900). The active set selector 980 can be implemented by dedicated circuitry and/or circuitry of the processor 940.

The beamformer 955 can perform any suitable beamforming functionality for the STA 900. The beamformer 955 can set and/or adjust one or more parameters associated with receiving and/or transmitting signals associated with the antennas 962 and 964 of the STA 900. The beamformer 955 can be implemented by dedicated circuitry and/or circuitry of the processor 940.

The STA 940 includes a data store 950. The data store 950 can store instructions that can be executed by the processor 940 to implement the features described herein. The data store 950 can store active set data and neighbor set data for the STA 900. The data store 950 can store spatial beam link strengths and/or link qualities. The data store 950 can store any other suitable data for the STA 900. The data store 950 can include any suitable memory elements arranged to store data.

Several elements included in the STA 900 may be coupled by a bus 990. The bus 990 can be a data bus, communication bus, other bus, or any suitable combination thereof to enable the various components of the STA 900 to exchange information.

As illustrated in FIG. 9, the STA 900 also includes a user interface 945. The user interface 945 can be any suitable user interface, such as a display and/or an audio component. In some instances, the user interface 945 can include one or more of touch screen capabilities, a button, a knob, a switch, or a slider.

### TERMINOLOGY, APPLICATIONS, AND CONCLUSION

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations, or events can be performed concurrently, e.g., through multi-threaded processing, interrupt processing, or multiple processors or processor cores or on other parallel architectures, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Additionally, the words “herein,” “above,” “below,” and words of similar import, when used in this application, shall refer to this application as a whole and not to any particular portions of this application. Where the context permits, words in the above Detailed Description of Certain Embodiments using the singular or plural may also include the plural or singular, respectively. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The word “coupled,” as generally used herein, refers to two or more elements that may be either directly coupled to each other, or coupled by way of one or more intermediate elements. Likewise, the word “connected,” as generally used herein, refers to two or more elements that may be either directly connected, or connected by way of one or more intermediate elements.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. Also, “determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), Flash, Java, .net, web services, and rich site summary (RSS). In some implementations, a UI may be included in a stand-alone client (for example, thick client, fat client) configured to communicate (e.g., send or receive data) in accordance with one or more of the aspects described.

As used herein a “transmit-receive point” (TRP) (which can alternatively be referred to as a transmission reception point) may refer to a transceiver device or one transceiver element included in a device. When included as a transceiver element, the device may include multiple TRPs. The TRP may include one or more antennas which are coupled to signal processing circuitry. The signal processing circuitry may be included in the device. The TRP may include additional elements to facilitate transmission or receipt of wireless signals for one or more UEs. Example of such elements may include a power source, amplifier, digital-to-analog converter, analog-to-digital converter, or the like. When a TRP is allocated, such as by a BBU, to provide service to a UE, the TRP may be said to be a “serving node” for the UE.

As used herein a “remote radio unit” (RRU) may refer to a device for controlling and coordinating transmission and receipt of wireless signals for one or more UEs. An RRU may include or be coupled with one or more TRPs. The RRU may receive signals from the TRP and include the signal processing circuitry. The signal processing circuitry may be selectively operated to facilitate processing of signals associated with different TRPs.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, circuit blocks and/or method blocks described herein may be deleted, moved, added, subdivided, combined, arranged in a different order, and/or modified. Each of these blocks may be implemented in a variety of different ways. Any portion of any of the methods disclosed herein can be performed in association with specific instructions stored on a non-transitory computer readable storage medium being executed by one or more processors. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A wireless communication device comprising:
an antenna; and
a processor in communication with the antenna, wherein computer-executable instructions, when executed by the processor, cause the wireless communication device to:
obtain a first scheduling message from an access point controller that allocates a first type of contention-based access period (CBAP) resource for serving a first station and that allocates a second type of CBAP resource;
transmit a first packet to the first station during the first type of contention-based access period (CBAP) resource;
transmit a second packet to the second station during the second type of CBAP resource;
obtain a second scheduling message from the access point controller that indicates that the first type of CBAP resource is converting into a second instance of the second type of CBAP resource allocated to the wireless communication device; and
transmit a third packet to the second station during the second instance of the second type of CBAP resource.

2. The wireless communication device of claim 1, wherein the first type of CBAP resource comprises a non-serve all stations (non-SAS) CBAP resource, and wherein the second type of CBAP resource comprises a SAS CBAP resource.

3. The wireless communication device of claim 2, wherein a second wireless communication device that is an outgoing access point for a third station transmits a third packet to the third station during a second instance of the first type of CBAP resource that is overlapping in time with the first type of CBAP resource.

4. The wireless communication device of claim 1, wherein the first scheduling message does not allocate any of the first type of CBAP resource to the wireless communication device for serving the second station.

5. The wireless communication device of claim 1, wherein the wireless communication device comprises an access point.

6. An access point controller comprising:
a network interface; and
a processor in communication with the network interface, wherein computer-executable instructions, when executed by the processor, cause the access point controller to:
determine that a first access point has served a first station and a second station in a first time period will not serve the first station in an upcoming second time period that follows the first time period;
transmit a first scheduling message to the first access point that allocates a first type of contention-based access period (CBAP) resource to the first access point for serving the first station and a second type of CBAP resource to the first access point;
determine that the first type of CBAP resource has expired; and
transmit a second scheduling message to the first access point that indicates that the first type of CBAP resource is converting into a second instance of the second type of CBAP resource allocated to the first access point.

7. The access point controller of claim 6, wherein the first type of CBAP resource is a non-serve all stations (non-SAS) CBAP resource, and wherein the second type of CBAP resource is a SAS CBAP resource.

8. The access point controller of claim 6, wherein the computer-executable instructions, when executed, further cause the access point controller to determine that the first type of CBAP resource has expired based on expiry of a timer.

9. The access point controller of claim 6, wherein the first scheduling message further indicates that the first access point is allowed to transmit a data packet only to the first station during the first type of CBAP resource.

10. The access point controller of claim 6, wherein a second access point serves a third station in the first time period, and wherein the computer-executable instructions, when executed, further cause the access point controller to determine that the second access point is not serving the third station in the second time period.

11. The access point controller of claim 10, wherein the first scheduling message allocates the first type of CBAP resource to the first access point for serving the first station during the second time period, and wherein a third scheduling message allocates a second instance of the first type of CBAP resource to the second access point for serving the third station during the second time period.

12. The access point controller of claim 11, wherein the first type of CBAP resource allocated to the first access point and the first type of CBAP resource allocated to the second access point each occur during one of an overlapping time period or a non-overlapping time period.

13. The access point controller of claim 6, wherein the computer-executable instructions, when executed, further cause the access point controller to set a time duration of the first type of CBAP resource to be one of equal to an absolute time duration or a value based on a period of running a scheduler function.

14. The access point controller of claim 6, wherein the first access point transmits a first packet to the first station during the first type of CBAP resource, wherein the computer-executable instructions, when executed, further cause the access point controller to transmit a third scheduling message and an activation trigger message to a second access point that will subsequently serve the first station in the second time period.

15. The access point controller of claim 6, wherein the computer-executable instructions, when executed, further cause the access point controller to:
determine that a second access point that does not serve a third station in the first time period will serve the third station in a third time period that follows the first time period; and
configure the second access point with a non-serve all stations (non-SAS) CBAP resource during the third time period.

16. An access point controller comprising:
a network interface; and
a processor in communication with the network interface, wherein computer-executable instructions, when executed by the processor, cause the access point controller to:
determine that a first access point that serves a first station and a second station in a first time period will not serve the first station in a second time period that follows the first time period;
transmit a scheduling message to the first access point that allocates a first type of contention-based access period (CBAP) resource to the first access point in which the first station is absent from a list of stations that the first access point is authorized to serve during the first type of CBAP resource;
receive a packet sequence identification number from the first access point of a first packet intended for the first station that has been flushed from a transmission queue of the first access point; and
transmit an activation trigger message to a second access point that will serve the first station that includes the identification of the first packet.

17. The access point controller of claim 16, wherein the computer-executable instructions, when executed, further cause the access point controller to transmit a backup copy of the first packet to the second access point prior to transmission of the scheduling message, wherein the activation trigger message causes the second access point to transmit the backup copy of the first packet to the first station.

18. The access point controller of claim 16, wherein the computer-executable instructions, when executed, further cause the access point controller to transmit a second packet to the first access point and a backup copy of the second packet to the second access point prior to transmission of the scheduling message.

19. The access point controller of claim 18, wherein the computer-executable instructions, when executed, further cause the access point controller to transmit the scheduling message and a second activation trigger message to the second access point prior to reception of the identification of the first packet from the first access point, wherein the second activation trigger message causes the second access point to transmit the backup copy of the second packet to the first station.

20. The access point controller of claim 19, wherein the computer-executable instructions, when executed, further cause the access point controller to transmit the activation trigger message in response to a determination that the second activation trigger message was transmitted within a threshold period of time of a current time and a sequence ID of the first packet is less than a sequence ID of the second packet.
